(19) United States
(12) Patent Application Publication
(10) Pub. No.: US 2017/0228743 A1
(43) Pub. Date: Aug. 10, 2017

(54) CROP FORECASTING WITH INCREMENTAL FEATURE SELECTION AND SPECTRUM CONSTRAINED SCENARIO GENERATION

(71) Applicant: Weather Analytics, LLC, Bethesda, MD (US)

(72) Inventors: Ellen Dee Cousins, Rockville, MD (US); Mark James York, Washington, DC (US)

(21) Appl. No.: 15/017,220

(22) Filed: Feb. 5, 2016

(51) Int. Cl. G06Q 30/02; G06N 5/02

(52) U.S. Cl. CPC G06Q 30/0202; G06N 5/022

(57) ABSTRACT

Systems and methods for creating linear models from historic crop yield reports and end of year crop estimates based on geo-spatial crop yield reports and a large plurality of index vectors wherein a large percentage of the index vectors are based on weather data variables and heuristic domain specific formulas that use weather data variables from a geo-spatially encoded weather data variable production system via incremental feature selection of index vectors and a crop yield predictor that determines a crop yield prediction and range of potential predictions via the use of principal component analysis of the weather data variable time series used in said plurality of index vectors and heuristic domain specific formulas.

### BACKGROUND

The field of the invention is crop yield prediction for a number of different varieties of commercial crop production. It employs a novel means of incremental feature selection wherein domain specific information is encoded into a large plurality of index vectors wherein a large percentage of the index vectors are using weather data variables from a weather data production system. And further, the system employs a novel spectrum constrained scenario generation process wherein principal component analysis and frequency analysis of the underlying weather data variable time series is used to generate termination point scenarios to predict crop yields and, in addition, produce a confidence interval for said crop yield predictions.

### DESCRIPTION OF RELATED ART

Attempts to mathematically model and predict crop yields have been the subject of academic and commercial research since at least the early 1980's and probably earlier. A good overview of the state of art appears in U.S. Pat. No. 6,662,185 to Stark.

The Stark patent, assigned to DeKalb Genetics, employs mixed model linear systems and data from testing (growing locations) to estimate the long term expected performance of new crop varieties. This is further used to estimate the commercial potential of said new plant variety. It thus appears to maintain its focus on new crop varieties as computed against baseline returns for a finite number of testing (growing) locations.

Another purported crop yield estimation technique involves the use of satellite data and the so-called normalized difference vegetative index (NDVI) as a source of daily information concerning crop conditions. U.S. Pat. No. 7,702,597 to Singh purports to use a piecewise linear regression method with break points to use NDVI and other variables to determine a potential crop yield.

Yet another purported crop product recovery model is U.S. Pat. No. 7,711,531 to Kapadi et al., assigned to Honeywell International. It purports to use three models in a combination comprising first order, second order and third order models more or less representing stages of sugarcane growth and harvesting to predict a recovery amount from a given field.

It is known to create weather index data from multiple weather data variables such as the multifactor temperature index, commercially called the ‘real feel’ index, claimed in U.S. Pat. No. 7,251,579 to Myers, et. al. assigned to Accuweather LLC.

### OVERVIEW

The present system uses a novel incremental feature selection process in combination with a novel principal component analysis of weather data time series data that generates a plurality of weather data variable time series scenarios that are constrained to the spectrum components of the underlying analysis of multiple years of weather data to predict crop yields.

### BRIEF DESCRIPTION OF FIGURES

FIG. 1 is a block diagram of a crop yield prediction system according to an embodiment of the present invention.

FIG. 2 is a detailed block diagram illustrating the methodology of the Index Generator block of FIG. 1 according to an embodiment of the present invention.

FIGS. 3A through F are block diagrams depicting the methodology of the Incremental Feature Selection Model Builder of FIG. 1 according to an embodiment of the present invention.

FIG. 4 is a block diagram illustrating the methodology of the Model Selector of FIG. 1 according to an embodiment of the present invention.

FIG. 5 is a block diagram illustrating the Principal Component Analysis of FIG. 1 according to an embodiment of the present invention.

FIG. 6 is a block diagram of the methodology of the Assimilation Fit of FIG. 1 according to an embodiment of the present invention.

FIG. 7 is detailed block diagram illustrating the methodology of the Optimal Interpolation Data Assimilation of FIG. 6 according to an embodiment of the present invention.

FIG. 8 is an example of a graphical output demonstrating the results of spectrum constrained processing according to the present invention.

FIG. 9 is a second example of a graphical output demonstrating the results of spectrum constrained processing according to the present invention.

FIG. 10 is a third example of a graphical output demonstrating the results of spectrum constrained processing according to the present invention.

FIG. 11 illustrates the output of an Mv5 linear model with index vectors generated by a spectrum constrained principal component system according to an embodiment of the present invention.

FIG. 12 is a histogram output of the Mv5 linear model according to an embodiment of the present invention.

FIG. 13 shows the crop yield prediction of the present invention applied to power the ancillary predictive measure of social unrest.

### DETAILED DESCRIPTION

Using weather data in predictive modeling is an inherently fickle endeavor. Weather data in almost all regions of the world is seasonal and can be highly variable within regional localities. In other regions, while seasonal, weather is not as variable and represents a more stable state. Classic numerical techniques, such as exponential smoothing, attempt to remove seasonality and ‘normalize’ data for use with predictive models and are understood to those with skill in the art. Other models attempt a numerical transformation of a time series to extract informational components. Fourier transformation, for example, transforms a repeating time series into sine and cosine components. Each of these methods has it respective strengths and weaknesses. Furthermore, each of these numerical techniques involves computer processing cycles and memory components. These computer processing cycles and memory components have actual computational and storage expense.

The present invention involves a specific technique that many provide the best tradeoff between accuracy, computing power, over fit, and under fit. The present invention employs a novel strategy of incremental feature selection and principal component analysis to build linear predictive models and select the ‘best’ for a particular region. It then generates a range of potential weather scenarios to power its crop yield estimations.

Incremental feature selection, as defined herein, is a system with heuristic characteristics for incrementally stepping through a large predetermined construct of index formulas that may impact crop yield in a particular geographic area. A potential taxonomic structure for generating formulas may be:

Monthly averages of each weather variable (precipitation, snow cover, max temp, min temp, cloud cover, etc.)

More date-specific averages of each weather variable (e.g. average temperature from April 15th through July 27th).

Squared differences from the ideal value for each variable (e.g. (July Precipitation—10 cm)̂2)

Excessive or excessively low soil moisture

Growing Degree Units

Freeze (temperatures below −1 C for more than two hours)

Sukhovey Drying Conditions

Disease susceptibility index (similar to Sukhovey Drying Index)

Percentage of the crop that is herbicide resistant

Percentage of the crop that has been genetically modified to be resistant to insects

Percentage of the crop that is blooming on a given date

Percentage of the crop that is planted by a given date

Average kg of fertilizer applied per hectare

Number of tractors per hectare of farmland

Price of Corn/Wheat/Soybeans

Many of these potential formulas from the above taxonomy may use weather data variables, such as those maintained and available at www.weatheranalytics.com:
Surface Temperature (2-m)
Surface Wet-bulb Temperature
Apparent Temperature
Wind Chill Temperature
Surface Dew Point Temperature
Heat Index
Surface Relative Humidity (2-m)
Total Cloud Cover
Precipitation
Categorical Rain
Categorical Snow
Categorical Freezing Rain
Categorical Ice Pellets
Surface Pressure
Surface Wind Speed (10-m)
Surface Wind Direction (10-m)
Diffuse Horizontal Radiation
Direct Normal Irradiation
Global Horizontal Irradiance
Upward Solar Radiation
Upward Terrestrial Radiation
Downward Terrestrial Radiation
Net Radiation
Extra-Terrestrial Direct Normal Radiation
Extra-Terrestrial Radiation
Potential Evapotranspiration
Surface Water Runoff
Mixing Height
100-200 cm Liquid Soil Moisture Fraction (total and non-frozen)
100-200 cm Soil Temperature
40-100 cm Liquid Soil Moisture Fraction (total and non-frozen)
40-100 cm Soil Temperature
Surface Degree Hours
Freezing Rain
Snowfall
Snow Event Index
Surface Wind Gusts
100-m Wind Speed
Surface (Ground/Water Surface) Temperature
2-m Maximum Temperature
2-m Minimum Temperature
2-m Maximum Specific Humidity
2-m Minimum Specific Humidity
Accumulated Convective Precipitation
Accumulated Large Scale Precipitation
Precipitation Rate
Convective Precipitation Rate
Snow Depth—questionable model accuracy
Snow Cover—questionable model accuracy
Water Equivalent of Accumulated Snow Depth
Precipitable water—Entire ATM Depth
Relative Humidity—Entire ATM Depth
Cloud Water—Entire ATM Depth
Cloud Work Function—Entire ATM Depth
Cloud Cover—Layers
Cloud Cover percentage (Convective Cloud Level)
Cloud cover percentage (Boundary Layer cloud level)
Pressure at (Convective cloud top & bottom level)
Cloud Top Level Pressure—Layers
Cloud Bottom Level Pressure—Layers
Cloud Top Level Temperature—Layers
Cloud Bottom Level Temperature—Layers
Mean Sea-level Pressure
Surface U Momentum Flux
Surface V Momentum Flux
Clear Sky Downward Solar (Shortwave) Flux
Clear Sky Downward Longwave Flux
Clear Sky Upward Solar (Shortwave) Flux
Clear Sky Upward Longwave Flux
UV-B Downward Solar Flux
Clear Sky UV-B Downward Solar Flux
Ground (Surface) Heat Flux
Surface Latent Heat Net Flux
Surface Sensible Heat Net Flux
Snow Phase Change Heat Flux
Upward Long wave Rad. Flux (Nominal top of ATM)
Clear sky upward Long wave Rad. Flux (Nominal top of ATM)
Upward Short wave Rad. Flux (Nominal top of ATM)
Clear sky upward solar Rad. Flux (Nominal top of ATM)
Base-flow Ground Water Runoff
Plant Canopy Surface Water
Canopy Water Evaporation
Potential Evaporation Rate
Direct Evaporation from Bare Soil
Transpiration
Sublimation
Surface Albedo
Freezing Level
Relative Humidity at Freezing Level
Highest Tropospheric Freezing Level
Relative Humidity at the Highest Tropospheric Freezing Level
Surface Geopotential Height
Convective Available Potential Energy
Surface-based Convective Inhibition
CAPE (0-180 hPa above sfc.)
Convective Inhibition (0-180 hPa above sfc.)
Surface-based Lifted Index
Best (4 layer) Lifted Index
0-1 km Storm Relative Helicity
0-3 km Storm Relative Helicity
U Component of 0-6 km Storm Motion
V Component of 0-6 km Storm Motion
Land-sea Mask
Ice Cover
Ice Thickness
Soil Type (Zobler Analysis)
Vegetation Type (SiB Analysis)
Vegetation Percent
Surface Exchange Coefficient
Surface Roughness
Surface Slope Type
Friction Velocity
Zonal Flux of Gravity Wave Stress
Meridonal Flux of Gravity Wave Stress
Aerodynamic Conductance
Total Ozone
PBL-Averaged (0-30 hPa above sfc.) Temp
PBL-Averaged (0-30 hPa above sfc.) Dew Point
PBL-Averaged (0-30 hPa above sfc.) Spec. Humidity
PBL-Averaged (0-30 hPa above sfc.) Relative Humidity
PBL-Averaged (0-30 hPa above sfc.) Precipitable Water
PBL-Averaged (0-30 hPa above sfc.) Parcel Lifted Index
PBL-Averaged (0-30 hPa above sfc.) U
PBL-Averaged (0-30 hPa above sfc.) V
Tropopause Pressure; Height; Temperature; U-Wind; V-Wind; Vertical Speed Shear
Maximum Wind Level Pressure; Height; U-Wind; V-Wind; Temperature
Sigma Level Temperature; Potential Temperature; Relative Humidity; U-Wind; V-Wind; Vertical Velocity
Potential Vorticity Level Temperature; Pressure; Height; U-Wind, V-Wind; Vertical Speed Shear
Hybrid Level Temperature; Specific Humidity; Height; U-Wind; V-Wind
1829 Meter Altitude Temperature; U-Wind; V-Wind
2743 Meter Altitude Temperature; U-Wind; V-Wind
3658 Meter Altitude Temperature; U-Wind; V-Wind
4572 Meter Altitude Temperature; U-Wind; V-Wind
5-Wave Geopotential Height (500 hPa)
5-Wave Geopotential Height Anomaly (500 hPa)
Geopotential Height Anomaly (500 & 1000 hPa)
0-10 cm Liquid soil moisture fraction (total and non-frozen)
0-10 cm Soil Temperature
10-40 cm Liquid soil moisture fraction (total and non-frozen)
10-40 cm Soil Temperature
0-200 cm Soil Moisture Content
Streamfunction
Velocity Potential
Upper Air Temperature
Upper Air Specific Humidity
Upper Air Relative Humidity
Upper Air Vertical Velocity
Upper Air Wind Direction
Upper Air Wind Speed
Upper Air Height of Pressure Surface
Upper Air Absolute Vorticity
Upper Air Ozone Mixing Ratio

Many of these variables and their related formulas are geospatially encoded to correspond to a predetermined location on the earth. In the case of variables available at Weather Analytics, the earth has been previously divided into area zones of about 35 kilometer by 35 kilometers, more specifically ⅓ degree latitude and longitude grid, in area. Each of these areas were given a predetermined weather station number wherein each of these virtual and data cleansed weather stations has a geo-location. At Weather Analytics, over 30 years of world wide weather data variables have been collected and placed onto the predetermined grid as defined by the virtual weather stations. Weather data variables used by the present system are generally climate forecast system re-analysis (CFSR) data that are previously collected and de-gribed from NOAA file servers. These world wide weather data variables have been previously checked and spliced by polynomial fit where necessary to provide an unbroken time series for each predefined ‘weather station’ for each weather data variable. It is understood that CFSR data incorporates the use of actual weather station observations and a computer re-simulation of the weather data variable in various atmospheric weather models. Therefore, actual weather data observations have been included in the re-casting or back casting of the weather data simulations. It is within the scope of the present invention to use other weather data variable sources such as METAR—meteorological observation measurements—from instrument data feeds or file servers.

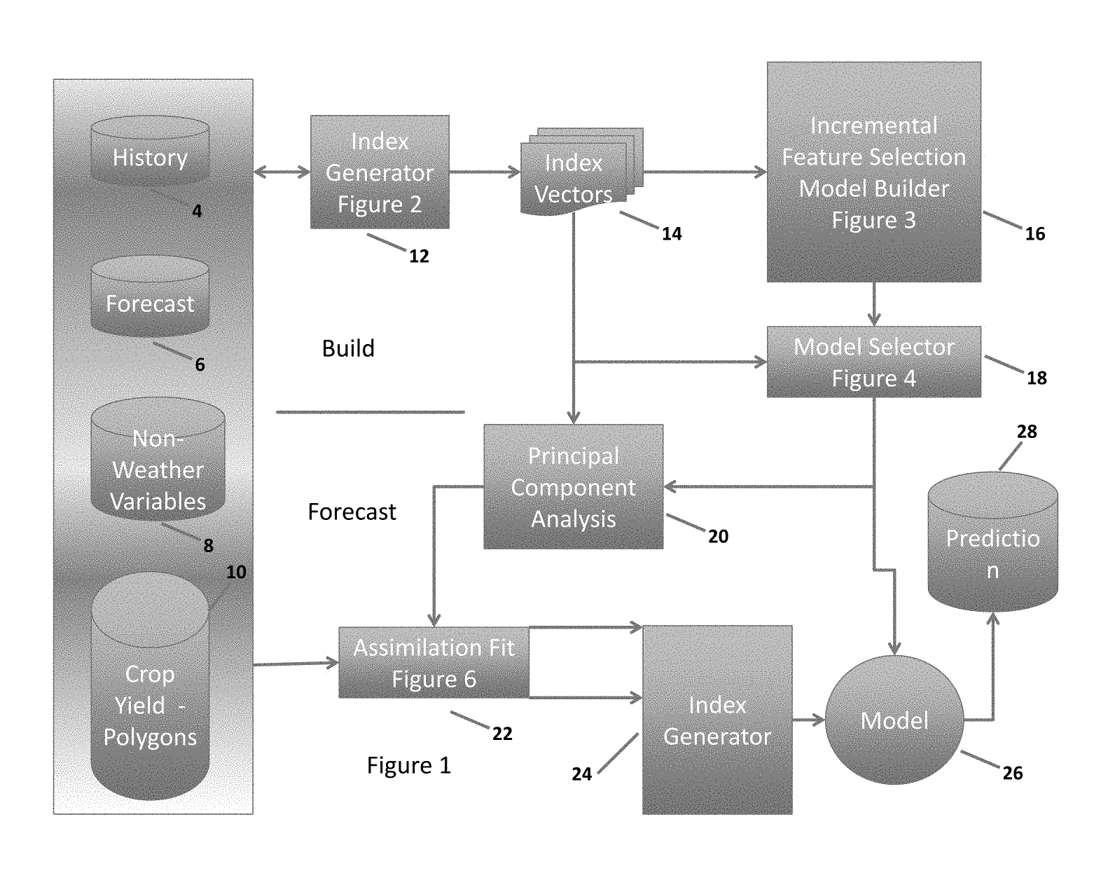

FIG. 1 shows a block diagram and overview of the crop yield prediction system of the present invention. It shows the history (4), forecast (6), non-weather data variables (8) and the crop yield polygon data structures (10). These can be actualized in a conventional database, data files or distributed object class data structures. FIG. 1 also shows the index generator configured to create index vectors (14). In general, an index vector is a value from a formula and a corresponding target variable such as a crop yield. It is preferred that the index vector definition and values are contained within an object structure so that if an index vector was one of the selected vectors used by the incremental vector feature selection model builder, discussed below, then the variable can be created from its object definition in the subsequent crop yield prediction mode. A plurality of index vectors are input to the incremental feature selection model builder. The model selector (18) rejects or accepts models and may cycle through index vectors and/or models until complete. The principal component analysis block is used to extract components from the index vectors to create an extrapolated input variable and index vectors having a spread of uncertainty. Here, the index vectors may be missing the target variable, as this is the variable the model may use to predict annual yields and the time series, for the data underlying the index vector may not yet have occurred. A spectrum of index vectors may be output from the assimilation fit and index generator blocks. This spectrum of vectors may be used to power the model (26) to result in a crop yield prediction and crop yield prediction certainty (28).

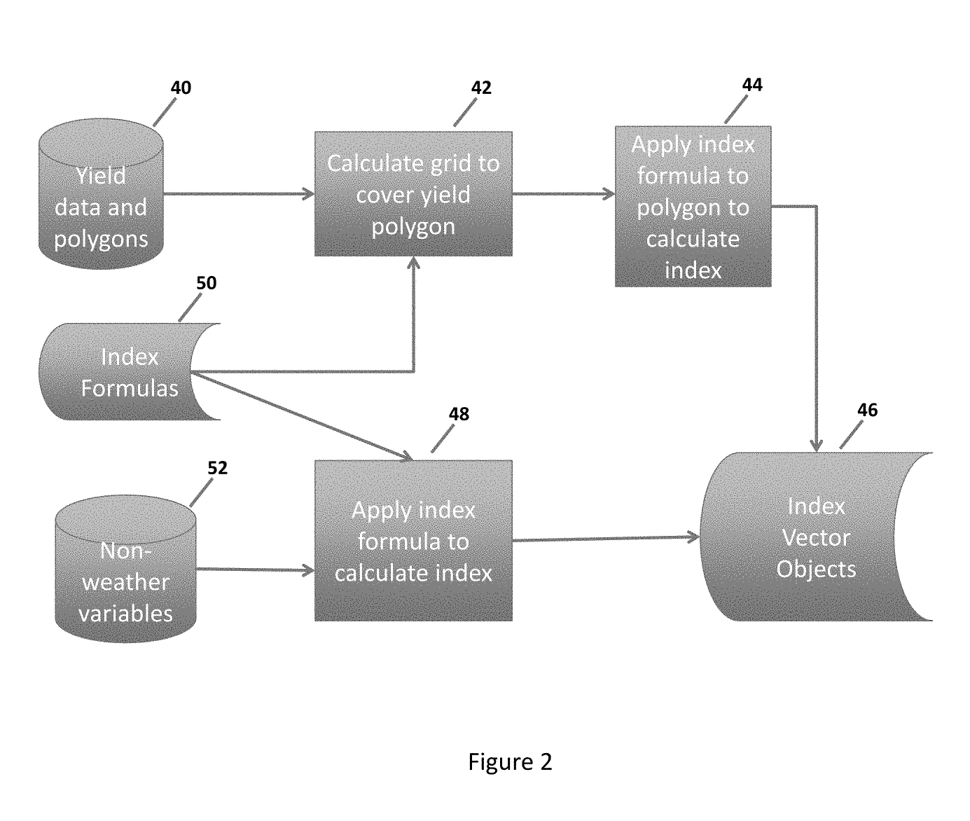

FIG. 2 shows a more detailed overview of the index generator block (12) from FIG. 1. The goal of the index generator is to create index vector objects. Crop yield data and the yield data polygon shapes may be stored or gathered in the yield data and polygon block (40). For example, crop yield data for corn for a county in Ohio, may be obtained from USDA, and a polygon for the shape of that particular county may be obtained from various mapping geospatial information system (GIS) sources. One free source is the American fact-finder portal provided by the United States Census Bureau. Other sources of geospatial boundary data include the United States Geological Survey at www.usgs.gov. And see also, www.nass.usda.gov for crop yield and crop-scape reports and estimates. Yield data and associated polygons may be used to query weather data variables from a long term weather data variable geospatial database available from Weather Analytics, www.weatheranalytics.com. For example, corn yield data for a county in Ohio and its associated polygon may be used to determine precipitation for the polygon shape for that particular county in Ohio. Since weather data variable data may be encoded at geospatial resolutions higher than the polygon associated with the county, several precipitation variables for the relevant time period may be returned by a query into a database or data object for weather data variables that fall within or very near the polygon shape associated with the crop yield report. Such multiple variable returns on the geospatial scale may then be combined, for example, to determine the average precipitation for the county. This step may be repeated to determine the necessary data associated with the index formula. In the preferred mode of the invention, many index formulas are contained within the index formula structure. Representative index formulas are discussed in the detailed description section of the present invention, below.

Once the weather data variables have been retrieved and the index formula applied, the values are combined to create an index vector object. The index vector object may include, the index formula, the names of the baseline weather data variables, the yield variable and yield value and the polygon associated with the object. The non-weather data variable can include data such as crop pricing data and fertilizer data. This data may be geospatially coded or contain additional data that is specific to a particular crop. For example, feed corn futures options price data may be specifically encoded to correspond to feed corn in contrast to white corn. Representative non-weather data variables data is discussed further below.

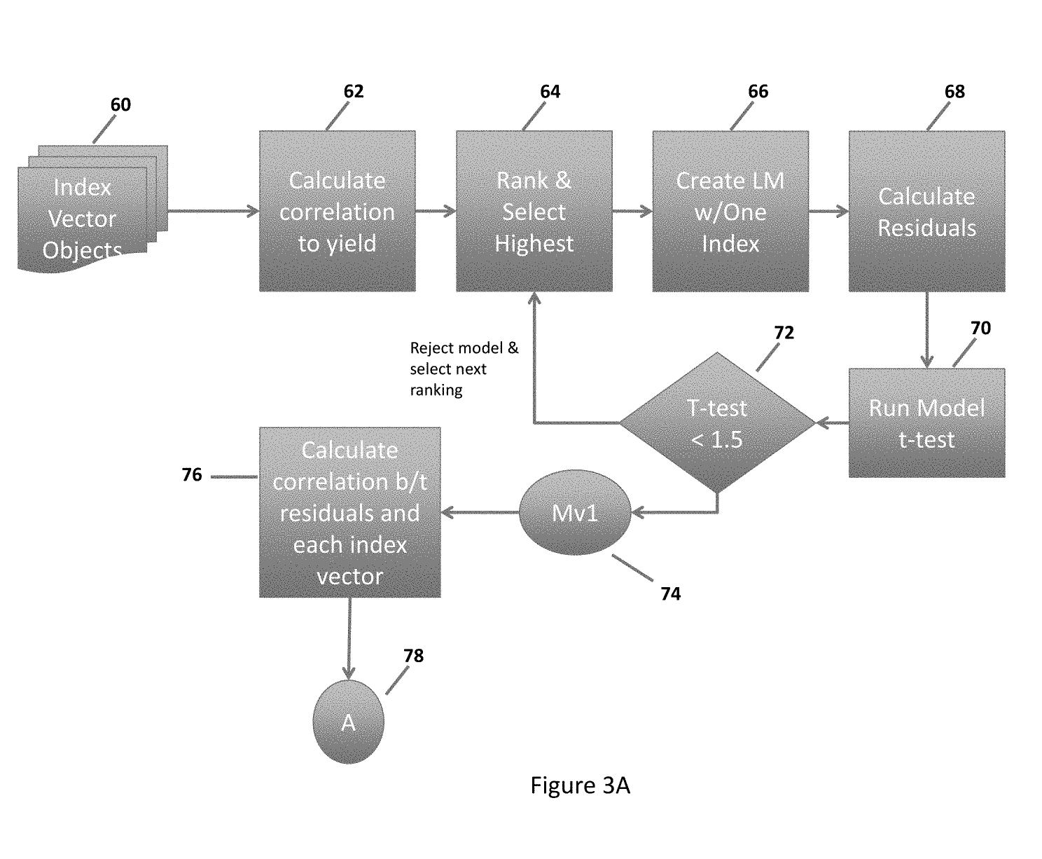

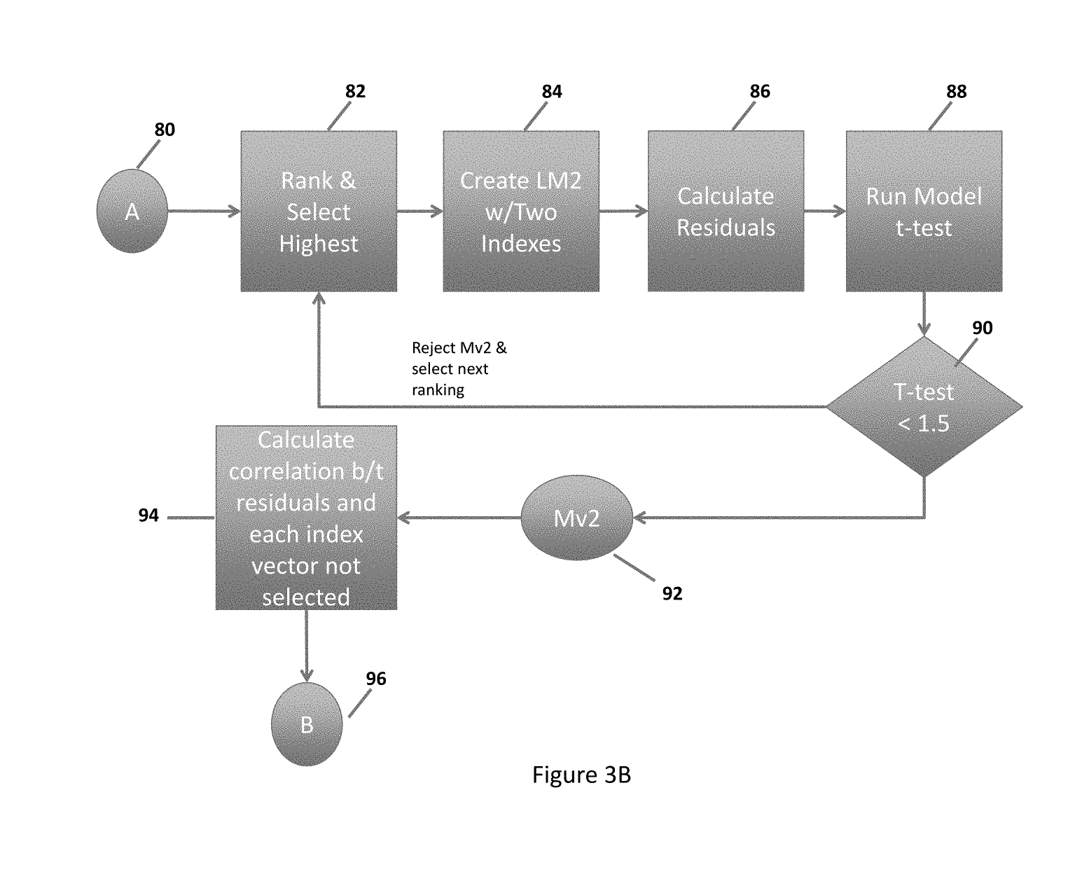

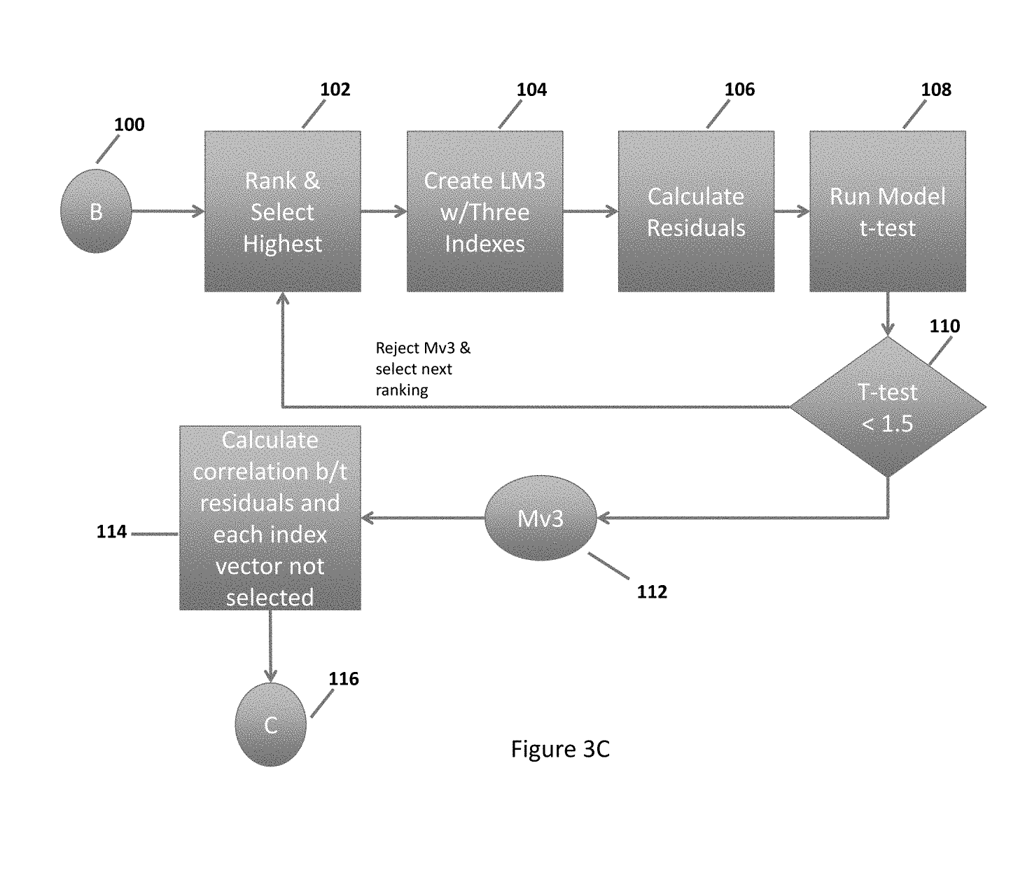

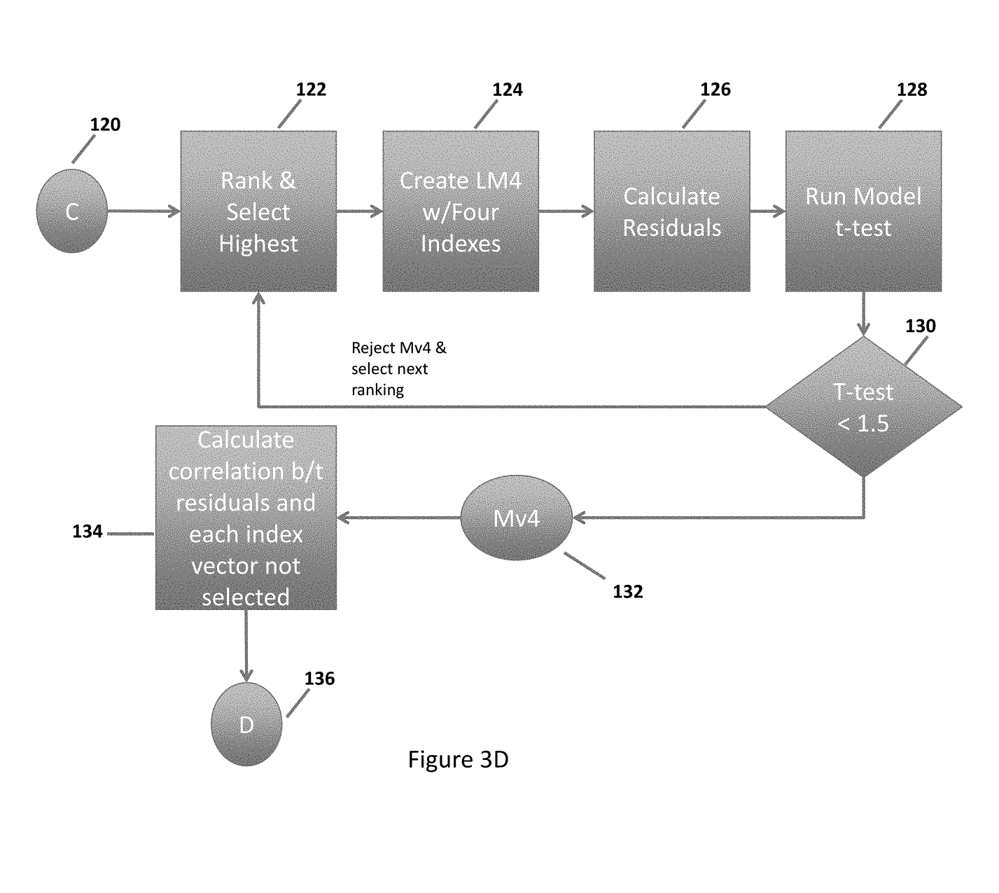

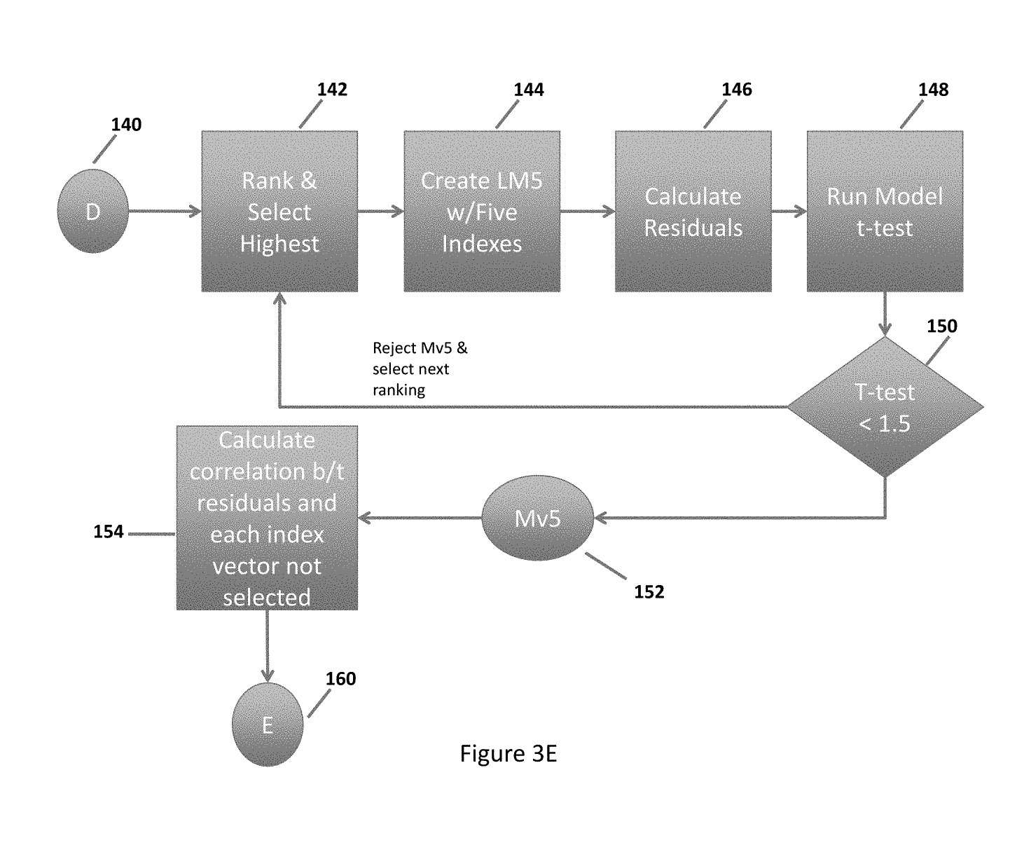

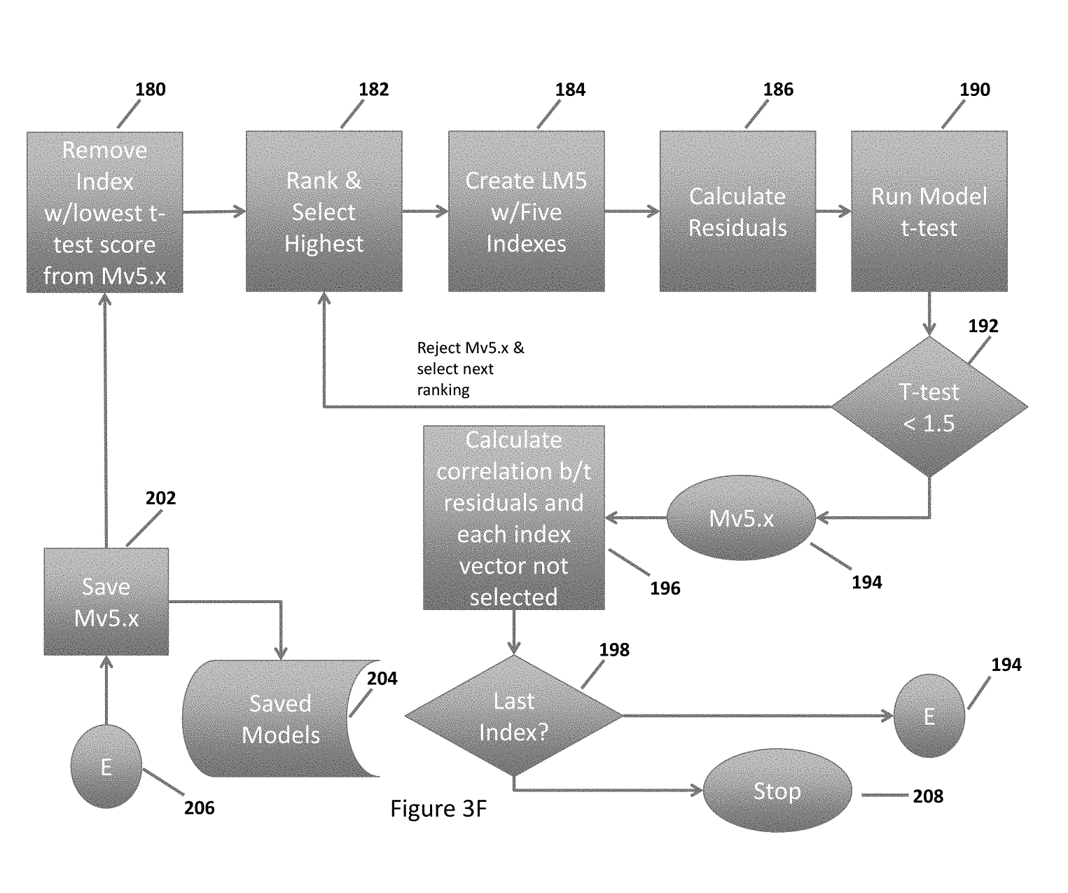

FIG. 3 A is part of the series of FIGS. 3 A through F depicting the incremental feature selection model builder (16). Index vector objects are input at (60). It is understood this is a multiple year representation of each index vector. For example, the precipitation formula and the yield data and yield polygon would be calculated for each year. In the case of Weather Analytics, this is at least 30 years of available weather data variables and, therefore, there is at least 30 years of index vectors for each index vector formula. The next block depicts a calculation of each index vector to its respective yield. Here again, this is done across the time domain with at least 30 years of index vectors. The correlation is then ranked and the highest correlated index vector is selected. It is understood that correlation between the input vector and a target measurement may be accomplished because there are multiple years of index vectors in which to calculate correlation. The selected index vector is then used to create a linear model with one index. Once the model is created, the residuals of the model are calculated. The next block (70) shows that a model t-test is conducted using the index vector selected and the linear model. If the t-test falls below a predetermined value, such as the depicted level of 1.5, that model may be rejected and discarded. The next highest ranking index vector is then selected and another model is created using this next index vector. Another linear model is created and its residuals are calculated. Here again, the t-test is run on the model and the index vector selected. And here again, if the t-test value falls below a predetermined threshold, for example, 1.5 the model may be accepted or rejected. The process of FIG. 3A then can repeat through all the index vectors until a model that exceeds the t-test threshold has been created. It is understood that the t-test threshold may be adjusted to initially reject many of the one index models created here in FIG. 3A. Once a model has been created that exceeds the t-test threshold, a model object Mv1 may be created. With the Mv1 model for each of the non-selected index vectors the next step calculates the correlation between the model residuals and each of the remaining index vectors. Once calculated, the incremental feature selection model builder proceeds to FIG. 3B. It is understood that Mv1 may be an object of a new class that may contain a slot for the linear model, a slot for index vector used to create that model and a slot for the t-test of the selected model. Methods, as further defined below may be defined to act on the new My data class.

FIG. 3B then depicts that the correlation between the Mv1 residuals and each index vector is ranked and the index vector with the highest correlation is selected. The next block shows that a two index vector model is built, using the index selected for the Mv1 model, and the new index vector. Residuals of the two index vector model are then calculated. A t-test is run on the Mv2 model and if the t-test is below a predetermined threshold value, here 1.5, the model may be rejected and the next ranking index vector is selected. In that case, the Mv2 model may have been rejected and a new Mv2 model is created using a different second index vector by discarding the first selected second index vector and maintaining the use of the same Mv1 index vector. The loop depicted between rank and select (82) create an Mv2 model (84), the calculation of residuals (86), and run model t-test (88) may loop until all index vectors have been tried and a two index vector model was created for each index vector. If no two index models passed the predetermined t-test threshold, the t-test threshold may be reduced until a two index vector model is selected. It is understood that multiple Mv2 models may be created and more than one model may have exceeded the predetermined t-test threshold. The models may then be ranked based on t-test and the best model selected as the determined Mv2 model. Once a two index vector model has exceeded the t-test threshold, the model Mv2 may be used to calculate the correlation between the residuals of each index vector that was not selected for the two index linear model. The incremental feature selection model builder may now proceed to FIG. 3C.

FIG. 3C selects the highest ranking correlation between the model residuals and the index vectors. The incremental feature selection process now creates a Mv3 three index vector model. The residuals are calculated and a model t-test is run. If the t-test does not exceed a predetermined threshold, here 1.5, the Mv3 model may be rejected and the next highest ranking index vector (102) may be selected. Here again, a new Mv3 model is created and again the residuals are calculated and the model is run against a t-test. If the Mv3 model does not exceed the predetermined threshold amount, here 1.5, the Mv3 model may be rejected, the next highest ranking index vector may be selected, and another new Mv3 model is created. If all index vectors are rejected as not exceeding the t-test predetermined threshold, the threshold may be reduced and the process repeated until an Mv3 model passes the predetermined threshold. Once an Mv3 model has passed the predetermined threshold, and it should be understood this could be the first pass, the Mv3 model is accepted. Incremental feature selection then calculates the correlation between the residuals and each index vector from the pool that has not been already selected for use with the Mv3 model (here that would, for example, be three vectors). As described above more than one model may be created and more than one model may exceed the predetermined threshold t-test value. In that instance the models may be ranked based on t-test score and the best model selected as the Mv3 model. Incremental feature selection may now pass the model to FIG. 3D.

FIG. 3D ranks and selects the highest ranking index vector from the pool of remaining index vectors. An Mv4 model is now created with the three index vectors already selected and the new highest ranking index vector from the pool. Once a model is created, the residuals of the model are calculated (126). The model is run against a t-test and if the model exceeds a predetermined threshold, here again 1.5, the model may be selected as an acceptable Mv4 (132) model. As described above, an Mv4 model that does not exceed the predetermined threshold amount may be rejected and the next highest ranking index vector may be selected. Once an Mv4 model has been selected as passing the threshold, incremental feature selection calculates the correlation between residuals and each index vector from the pool that has not been used by the Mv4 model. Here, that would be 4 index vectors. Incremental feature selection now may proceed to FIG. 3E.

FIG. 3E ranks and selects the highest ranking index vector form the pool of index vectors. An Mv5 model is now created using the previously selected four index vectors and the highest ranking index vector (not already used) from the pool. The model residuals may be calculated and the model run against the t-test. Here again, if the model does not exceed the predetermined t-test threshold, the model may be rejected and the next highest ranking index vector may be selected from the pool to create a new Mv5 model. As described above, the incremental feature selection may loop through all the index vectors in the pool until the model t-test exceeds the predetermined threshold. Here again, the threshold may be incrementally reduced until an Mv5 model exceeds the threshold. Here again, more than one Mv5 model may have passed the t-test threshold and the more than one models may be ranked based on the t-test score to select the best model. Once an Mv5 model has been selected, the correlations between the residuals and each vector not already selected from the index vector pool may be calculated. Incremental feature selection may now proceed to FIG. 3F.

FIG. 3F depicts a procedure different than that shown in FIGS. 3A-E. It is understood that a model containing 5 index vectors has heuristically demonstrated to be one of the better predictors without the pitfalls of an over-fit model. An Mv5 model, having a t-test exceeding the predetermined threshold is passed to FIG. 3F. This model may be saved. The 5 index vectors used by Mv5 are ranked according to a t-test and the lowest scoring index vector is removed from the index vector pool. The process of FIGS. 3A-E may then execute with the removed index vector flagged as removed from the vector pool. Another Mv5 model may be created and if that Mv5 model exceeds the predetermined t-test threshold it may be saved. That model may be used to calculate the correlation between the residuals and each index vector not selected by that model. The lowest scoring index vector may be flagged as removed from the index vector pool. FIGS. 3 A-E may then execute to create another Mv5 model with the appropriate index vectors removed from the index vector pool. This process of FIG. 3F may then repeatedly create and save Mv5 models until the last index vector is tested and removed from the index vector pool. The result of the incremental feature selection process of FIGS. 3A-F should result in multiple stored Mv5 models that have been tested to exceed the predetermined threshold t-test value.

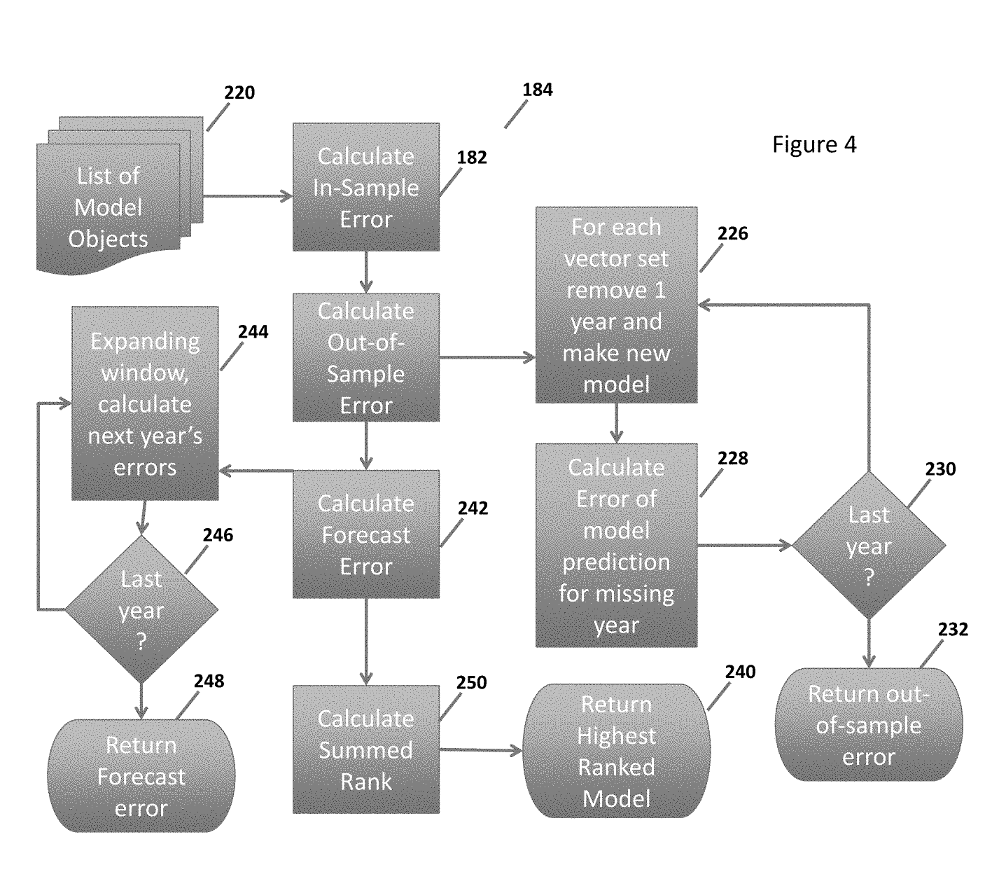

FIG. 4 is a block diagram of the model selector shown in FIG. 1. Here, a list of model objects is input to the process. In this case, a list of Mv5 model objects is input. For each model, an in-sample error is calculated and an out-of-sample error is calculated. For each vector of each model one year of data is removed and a new model is created using the index vectors identified for that model, but missing one year of data. Next an error of the model prediction for the missing year is calculated. This process is repeated for each year of data contained in the index vector. A sum is calculated for out-of-sample error scored by the model. Each model is also tested using an expanding window of years beginning at the first year of the index vector. An error is calculated for the next year data in the expanding window arrangement. This is repeated until the index vector reaches its last year of data. The sum of this forecast error is returned for each model. Each model is thereby scored for in-sample error, out-of-sample error, and forecast error. These scoring parameters are then used to create a rank of the models. The model selector of FIG. 4 may return the highest ranked model or a list of models with their respective rankings.

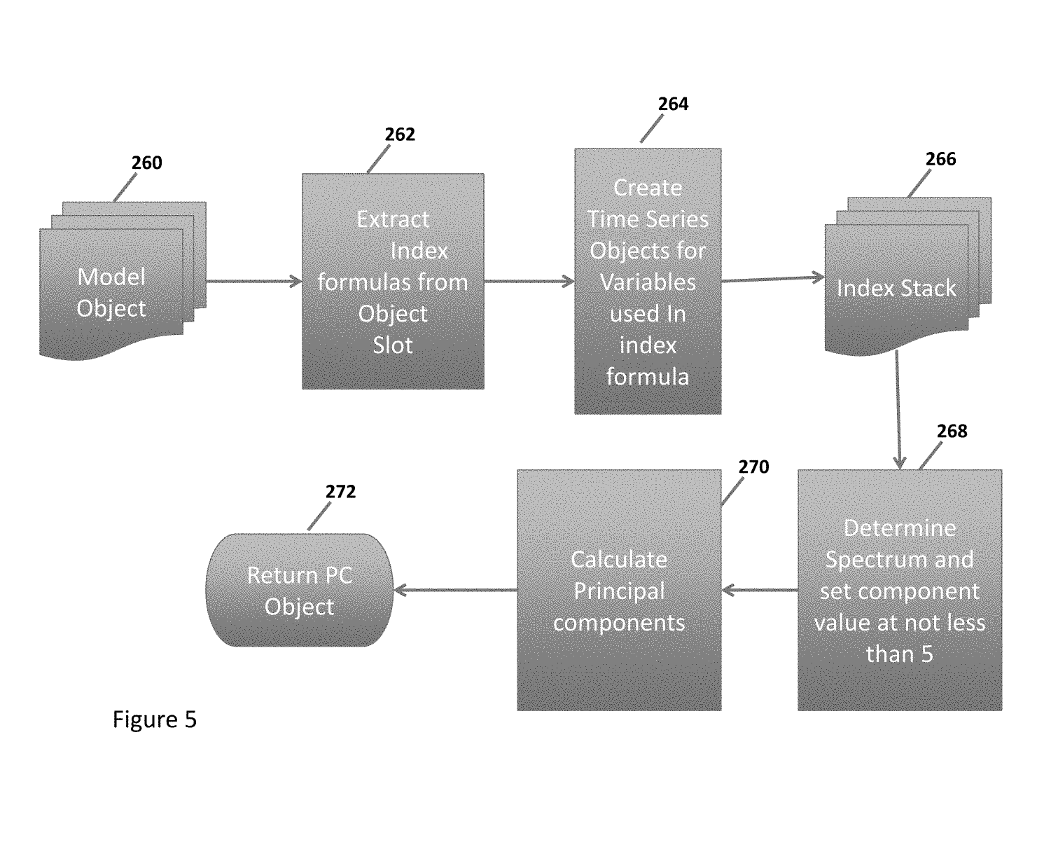

FIG. 5 shows a block diagram of the principal component analysis block (20), i.e. a principal component generator, shown in FIG. 1. A model object may be input. This is typically an Mv5 model. From the model object the index formula may be extracted from the Mv5 linear model object slot containing the index formula. Here, this may be from the index vector object definition. Next, a time series object may be created from the index formula retrieved from the model object slot. An index stack may be created which is a stack of time series objects, one for each calendar year. As noted above, in the case of Weather Analytics, this may be at least 30 years and therefore a stack of 30 time series objects. The spectrum for the index stack may be determined and the components value may be set. Heuristically, the component value (the number of components to be used to model the time series) is not set less than 5. The principal components for the time series index stack may now be determined for each index vector that was identified by the model object. FIG. 5 may then return a principal component object for each weather data variable used by the index vector identified in the model object slot.

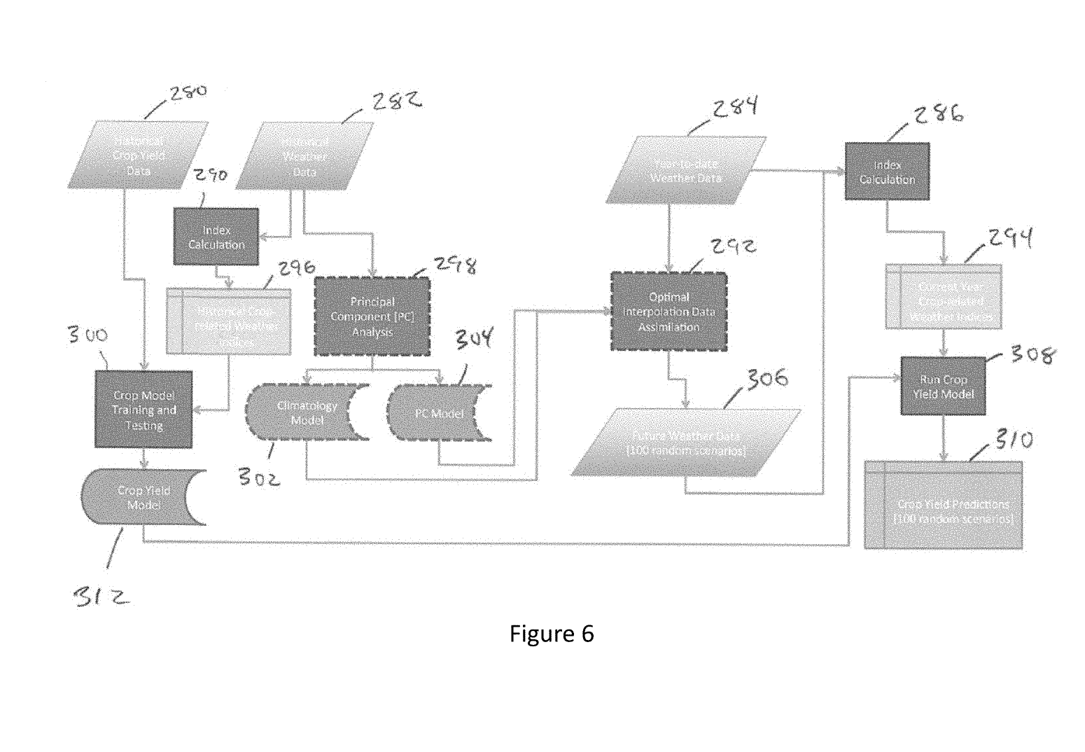

FIG. 6 is a block diagram of the assimilation fit (22) block, i.e., an assimilation fit generator, shown on FIG. 1. It also provides another overview of the system. Historical crop yield data and historical weather data can be combined with index formulas to create historical crop related weather indices. These are also called index vectors or index vector objects in the present specification. Historical weather data can also be used as shown in the previous figure for principal component analysis. The principal component model may be combined with climatology models to create artificial index vectors for use with optimal interpolation data assimilation (292). Year-to-date weather data variables formatted to conform with the weather data used to generate the index vectors may be input to the optimal interpolation data assimilation block. The output of the assimilation fit may be 100 random selected weather index scenarios with the understanding that these selected scenarios are constrained by the components determined for the 30 years of weather data variables analyzed. These weather data scenarios may then be applied to the formula slot of the index vector object from the model previously determined for the appropriate geospatial location. The index vector approximation may then be run through the Mv5 model and a crop yield prediction may be obtained.

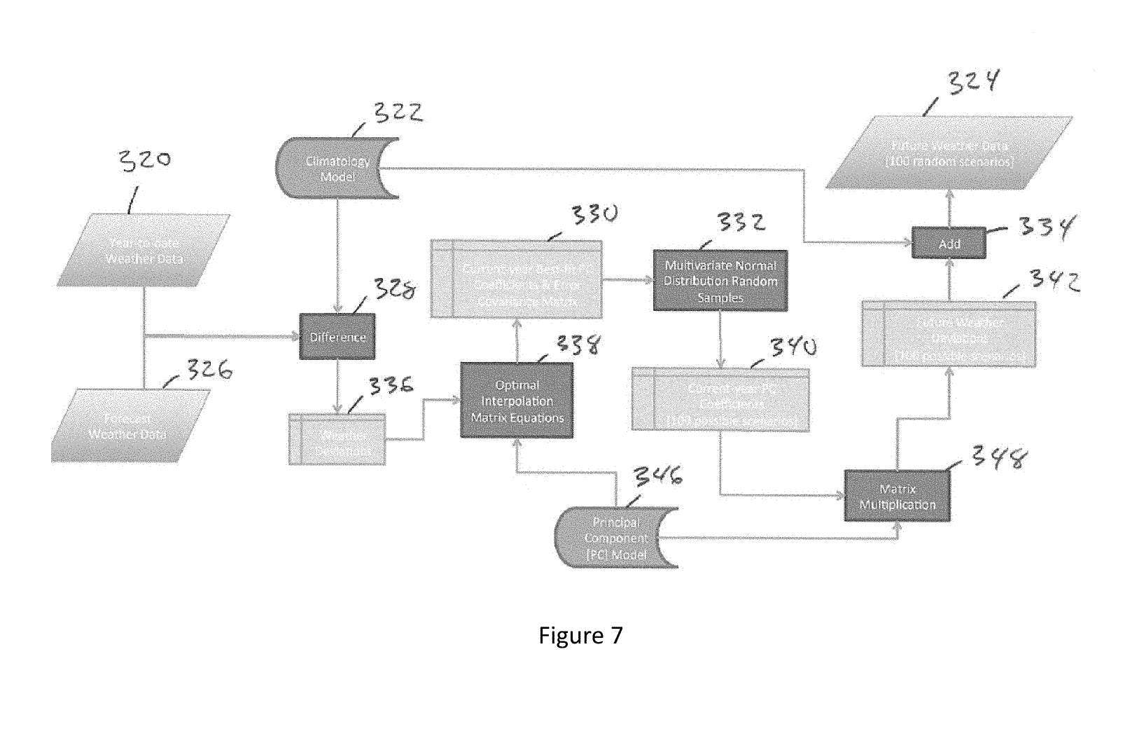

FIG. 7 shows a more detailed block diagram of the optimal interpolation data assimilation (292) from FIG. 6. Year-to-date weather data may be combined with forecast weather data and climatology model data to create a scenario for the weather data variable for the current year. This would be necessary in the case wherein the weather year is not complete and the yield data does not have a corresponding intermediate indicator, i.e., only an annual actual yield report. The difference between these data vectors may be taken from the climatology model to create weather deviations for the remaining weather year. A previously determined principal component model can have the optimal interpolation matrix equations (discussed in this specification) and apply the weather deviations to create a current year best-fit principal component coefficients and error covariance matrix. A multivariate normal distribution random sample may then be applied. These multivariate normal distributed samples may then be applied to the current year principal component coefficients. This then creates, for the purpose of generating a predictive confidence, 100 possible end of year weather scenarios. Matrix multiplication maybe used with the previously determined principal component model and the current year principal component coefficients to generate at least 100 future weather deviation scenarios. These deviations may be added to the predetermined climatology model to generate a set of future weather data scenarios. These may be returned to FIG. 6 and applied to the predetermined Mv5 model for crop yields.

A user display of the forecast system can also be included as part of the present invention. It may include controls for crop selection, e.g., corn, sorghum or millet. Further, it may include controls for selecting a geographical location. A time series may be used to represent and display changes to the annual crop forecast. A geographic display and color index crop yield score may be encoded onto the geographical display map.

### Data Conditioning

The present invention begins its processing by collecting crop yield data from the most reputable sources. In the United States, this source is the United States Department of Agriculture's National Agricultural Statistics Service (USDA-NASS). Outside of the United States, various governmental agencies are used, including Eurostat within the European Union and Brazil's Companhia Nacional de Abastecimento (CONAB). Once collected, these data are normalized to allow inter-year comparisons of crop yield outcomes to be made. As crop yields are trending upward in nearly every country of the world, the goal is to approximate the underlying yield trend and subtract it from the yield data. To determine the trend, various approaches are tried, including simple linear trend lines using least-squares regression, second or third order polynomials and logistic equations. The best fit is determined based on the sum of squared errors. Once the trend is determined, a normalized set of yields is created by subtracting the trend from the true yields.

With a normalized data set of crop yields in which an appropriate weight matrix has been determined as described above, the present system may begin its processing by first creating a large pool of index vectors (14). Index vectors may be an object with predetermined slots and methods that may subsequently be used by the sub-systems. Here, for example, crop yield data pertaining to a particular crop, such as corn, may be determined from reporting agencies such as the United States Department of Agriculture. In certain regions of the world, such as the continental United States, crop yield may be reported down to individual farms or parcels. For the purpose of the present invention, crop yields at the county level may be used to power the system for domestic crop yield predictions. In this case, a polygon for the shape of the county may be used as the reporting area. These may be stored in the system. Therefore, crop yield and its associated polygon may be retrieved by the system (40). A grid to cover the polygon may be calculated (42) or, in other words, a predetermined number and identifications of so called weather stations that are covered by the polygon may be determined. This step may be used to determine which predetermined weather stations fall within the polygon. Based on the particular index formula, the data from the potentially multiple weather stations falling within the polygon may be used for the index calculation. For example, if 4 weather stations were identified as falling within the polygon, those 4 weather stations maybe identified WA20034, WA 20035, WA20036, WA20037 and stored in a list object which may be a slot in the index vector object. Weather station identification may be accomplished by a getStation method defined for the index vector object type. If, for example, an index formula, of July precipitation, would be actualized as the 24 hour sum of precipitation for each of the predetermined weather stations and those 4 precipitation amounts may be summed and then divided by the number of stations, here it would be division by 4 since there are four weather stations determined to fall within the polygon for the county. This would then be summed for the number of July days. This calculation would be repeated for each year in which the system maintains weather data and yield data. In the case of Weather Analytics, this is at least 30 years of data, and therefore, there would be at least 30 index vectors created for each formula. A slot may be defined in the vector object to identify which year the object is corresponds for example, 1994. A slot may be defined in the index vector object to identify when the object value is determined from observational data. In this July average precipitation example, July 31 would be the date stored in the observational slot to identify to the system when observational data in contrast to principal component data should be used by the predictive system. In this case it would be July 31^{st}. It is understood that slot may be defined for the index formula, for example, July precipitation may translate into a query formula of the sum of July 1 through July 31 precipitation by all hours divided by 31. It is understood that additional slots such as the principal component model object for the index vector may also be present in the index vector object. The index vector generator at (44) may therefore be used to create index vectors for many weather data variables in the manner described herein for each of the many index vectors predefined for the geospatial location.

Index formulas (50) may also be predetermined for non-weather data variables (52) and those non-weather data variables may have been collected and stored in a data repository or object (52). For example, the price in early April for corn futures for an option contract that may affect the geo-location of the corn crop yield. For another example, the price of nitrogen fertilizer in June. These external factors may affect crop yields. Here for example, the hypothesis might be that a low price for fertilizer in June may result in more fertilizer being used in that geo-spatial polygon, and that might affect the eventual crop yield. The index generator may apply the index formula to these non-weather data variables to calculate an index and create an index vector object (48). These index vector objects may be of the same class as the weather data variable objects and may share the methods defined for the index vector objects. It is understood that a list of index formulas may be maintained and this list may be used to create index vector objects to be placed into the index vector object pool (46). Typically, the non-weather data variables and weather variables index vector objects would have equal time basis, for example, 30 years of index vectors, to provide an equal set of index vector objects to the index vector object pool. It is understood that the index vector pool may also be created by scripting language such as Python or R to create the index vector objects. This may achieve, albeit with much more work, the functions of the index generator (12) with the goal of achieving the index vectors objects (14) having that same vector depth, i.e., all having the same number of years available for each of the index formulas.

Now having a pool of index vectors (14) the system may proceed to the incremental feature selection model builder (16) show in part in FIG. 3A. A first index vector object, e.g., spanning 30 years of index formula will have two columns, i.e., vectors of data, a calculated index value and a corresponding yield value. In other words, an x and corresponding y vector. Here, the yield value is the normalized yield value and described herein elsewhere. With an x and corresponding y, the correlation may be calculated.
cor(x, y=NULL, use=“everything”,

method=c(“pearson”, “kendall”, “spearman”))

The correlation for each index vector may be calculated and the results ranked. The highest ranking index vector may be selected (64). A linear model may now be built (66) using the selected index vector.
Mv1.1m←lm(adj.yield˜index.value, data=index.vector.df)

For FIG. 3A the formula is the one index vector x in a relationship with corresponding vector y. Therefore Mv1.1m is the linear model determined at (66). The residuals of the model may then be calculated (68):
Mv1.res←resid(Mv1.1m)
   The t-test is then calculated (70) with the index vector selected and the model output ŷ.
Mv1.t-test←t.test(index.value, model.ŷ)

The t value of the t-test may be extracted as t=Mv1.tres[1]. A determination can then be made as to whether it is true that the t-test results are greater than a predetermined threshold value (here 1.5). For example, Mvl.tres[1]>1.5. This may result in a logical return of either true or false (72). If the t-test result is great then 1.5, then the Mv.1 model is accepted as a preliminary Mv1 model (72). If the t-test fails to exceed the predetermined value (here 1.5), the model may be rejected (72). In the case of a model rejection, the next highest ranking index vector with the highest scoring correlation is selected (64). Another linear model may be created (66) and the model residuals may be calculated (68). The new Mv1 model may then be evaluated with a t-test (70). If the model t-test does not exceed the predetermined value (here 1.5), that model may be rejected (72). If the model is rejected, then the next highest ranking index vector may be selected (64), another model may be created (66), the model residuals may be calculate (68) and a t-test may be conducted on the model (70) to determine if the model exceeds the predetermined threshold (72). This model rejection t-test loop (64), (66), (68), (70) and (72) may loop through the entire pool of index vectors. If all index vectors in the index pool are rejected as not exceeding the pre-determined t-test value, the threshold value may be decremented (1.5−0.1=new threshold) and the loop may begin again starting with the highest ranked (highest correlation) index vector. Making the heuristic assumption that at least one index vector will exceed the predetermined threshold value in the first pass through the index vector pool (72), a first Mv1 model may be accepted (74) and preferably saved as a model object Mv1.

The residuals of the Mv1 model may then be calculated (76) or (68) and those residuals, since the residuals are a vector of equal length to the index vector, may then be measured for correlation between the residuals and each index vector remaining in the index vector pool (76). This may be passed (78) from FIG. 3A to the next step in the incremental feature selection process on FIG. 3B (80).

FIG. 3B is showing that the correlation may then be sorted in descending order and the index vector with the highest correlation to the Mv1 model residuals may be selected (82). A linear model using the index vector selected for the Mv1 model and the index vectors selected (82) may be used to create a new Mv2—two variable linear model (84).

Mv2.1m←lm(adj.yield˜index.value.1+index.value.2)

This creates a linear model in the form of:

Yᵢ=β₀+Xᵢβ₁+Zᵢβ₂+εᵢ

Wherein adj.yield is the Y index value, X is the indexed value for the first index vector that was selected for use with the Mv1 linear model, and Z is the indexed value of the next selected index vector from the index vector pool. The residuals of the model may then be calculated (86):
Mv2.res←resid(Mv2.1m)
   The t-test is then calculated (88) with the index vectors selected and the model output ŷ.
mv2.sum←summary(Mv2.1m)
var1.t.test←mv2.sum$coeff[,‘t value’][2]
var2.t.test←mv2.sum$coeff[,‘t value’][3]

The summary function of the R core language calculates, inter alia, the t value of each of the index vectors and the t value of the intercept. Here, each t-test value is compared to the predetermined threshold value of 1.5. It is understood that Python language provides methodologies for calculating t-tests, residuals and the other calculations herein, and Python is the language used in the preferred operational deployment of the present system. If either of the t-test values fail to exceed the threshold (90), then that Mv2.1m model is rejected and the next ranking correlation of the index vectors from the index vector pool (82) may be selected and a new Mv2.1m linear model may be created using the same first index vector and a new second index vector (84). Again the model residuals may be calculated (86) and the t value from a t-test may be calculated on the new Mv2.1m linear model (88). The t-test value for each of the index vectors may be compared to the predetermined threshold value (here 1.5) and again if either of the t values is below the predetermined threshold value, then (90) the model may be rejected and the next highest ranking correlation index vector (82) may be selected from the index vector pool and another Mv2.1m liner model may be created (84). This select (82), create model (84), t-test (88) and threshold (90) loop may be repeated until all the index vectors form the index vector pool have failed. In this case the predetermined threshold value may be decremented by a predetermined amount, as shown and described above, and the process may begin over with the first highest ranking correlation index vector (82). Typically, on the first pass through the index vector pool an Mv2.1m linear model will exceed the predetermined threshold value (92) and the Mv2.1m model may be saved. Now the residuals of the Mv2.1m model may be calculated.

Mv2.res←resid(Mv2.1m)

The correlation between the residuals (Mv2.res) and each index vector in the index vector pool may be calculated and the index vectors ranked in descending order.

pool.df←cbind(pool.df, Mv1.res)

cor.to.residuals←cor(pool.df)[‘Mv1.res’,]

new.ranked.pool.df←pool.df[,order(cor.to.residuals, decreasing=TRUE)]

The ranked index vector pool and the Mv2.1m linear model may then pass (96) to FIG. 3C (100). The highest ranking correlation between the indexes in the index vector pool and the residuals of the Mv2.1m linear model may then be selected (102). The system may now create a three vector linear model Mv3.1m (104). The model residuals may be calculated (106) and a t-test may be run on the Mv3.1m linear model (108). Again, the t-test value for each index vector can be determined as to whether it exceeds the predetermined threshold (here again 1.5) and if any of the t-test values do not exceed the predetermined threshold the model may be rejected and the next highest ranking correlation of the index vectors from the index vectors remaining in the index vector pool may be selected (102) and a new three variable model may be created (106). The t-test may be calculated on the new Mv3.1m linear model (108) and the threshold determination may be calculated (110). Again the system may loop through the entire remaining index vector pool rejecting (110), selecting the next vector (102), creating a new model (104), testing (108) and rejecting or accepting (110) until the pool of index vectors is exhausted or a model has passed the predetermined threshold (110). If the pool is exhausted without a model passing the threshold test, here again the threshold may be decremented and lowered until a model passes the threshold. Once a model has passed the threshold (110) it may be saved (112). The correlation between the model residuals and the index vector remaining in the index vector pool may then be calculated and the index vector pool may be ordered by the descending order of the highest correlation calculation between the remaining index vector and the model residuals (114). The system may pass these data records (116) to FIG. 3D (120).

FIG. 3D. Having calculated and ordered the remaining index vector pool in descending order of the value of the correlation between the model residuals and the index vectors in the index vector pool (122), the highest ranking index vector may be selected. The system may create a four-index vector linear model (124).

Mv4.1m←lm(adj.yield˜index.value.1+index.value.2+indexvalue.3+index.value.4)

And again the system may calculate the model residuals (126) and run a t-test on the Mv4.1m model (128). The system may determine whether all the t-test values for each of the four index vectors exceed the predetermined threshold 1.5. And, if so, the Mv4.1m model may be accepted (132) and saved. The system may then calculate the correlation between the index vectors remaining in the pool (e.g., those index vectors that have not already been accepted for use in the Mv4.1m model) and the model residuals (134). The system may then pass the model and the data records (136) to FIG. 3E. As described above, rejected Mv4.1m models may loop through the selection of a next index vectors from the index vector pool until and model exceeding the predetermined threshold is obtained.

FIG. 3E demonstrated the Mv4.1m model and data records passing (140) from the four index vector linear model section to this section concerning the creation and selection of a five index vector model. It is understood that the five index vector model has been empirically determined to be the best mode of obtaining a good fitting linear model of the agricultural system. Good fit, as used herein, means the best trade off between computing power, predictive capability and avoiding the pitfalls of an over-fit model, i.e., a model that fits the data well but is a poor model when used to predict a potential crop yield. Here again, the highest ranking correlation between the remaining index vector in the pool of index vectors to the residuals of the four index model may be selected (142). The system may now create a five index vector linear model.

Mv5.1m←lm(adj.yield˜index.value.1+index.value.2+indexvalue.3+index.value.4+index.value.5)

Here again, as described above, FIG. 3E demonstrates that the model residuals may be calculated (146) and a t-test may be run on the Mv5.1m model (148). The t-test results may be determined whether they all exceed the predetermined threshold (150) and the model may be accepted and saved (152). Models not exceeding the t-test threshold may be reject and the system may loop through the index vectors remaining in the index vector pool (142)(144)(146)(148)(150) until an Mv5.1m model is accepted (152). Having now followed the above described methodologies to arrive at a first mv5.1m model the herein described incremental feature selection now shifts to its concluding and end points as described in FIG. 3F.

The first Mv5.1m model and data records may enter (206) from FIG. 3E. The model may be saved (202) in a suitable storage location (204) or data structure. A t-test may be performed on the Mv5.1m model (180) and the lowest scoring index variable may be removed from the model and flagged as removed from the index vector pool. The residuals of the Mv5.1m model, which may have been previously determined, may be used to calculate the correlation with the index vectors remaining in the pool (in this instance that would be the four index vectors remaining from the Mv5.1m linear model and the lowest t-test scoring vector that was removed). The next highest ranking correlation index vector is then selected (182) and a new Mv5.1m linear model is created (184). The residuals of the model may be calculated (186). A t-test may be run on the model (190). If all the t-test values for the five index vectors exceed the predetermined threshold, that model Mv5.x (194) may be saved. If the model t-test for each index vector used in the model does not exceed the predetermined t-test value, e.g., 1.5, that model may be rejected and the next highest ranking correlations of the remaining index vectors may be selected (182). The system therein may loop through (184)(186)(190) until a model is created wherein all the index vectors exceed (192) the predetermined threshold value, e.g., 1.5. Returning now to a model that does exceed the predetermined threshold (192), the model may be saved and the residuals of the model may be calculated (196) and the correlation between the model residuals and the remaining index vectors in the index vector pool may be calculated. If it is not the last vector from the index vector pool (198), meaning there could be potential additional vectors that could discover a superior model, the system may pass the model (200) for the model to be saved (202) in a storage location or object (204). The index vector with the lowest scoring t-test may then be removed from the Mv5.x model and flagged. The highest ranking index vector, that is, the index vector with the highest correlation value to the model residuals (180) may be selected and a new Mv5.x model may be created (184). The model residuals may be calculated (186) and a t-test may be run on the model (190). If all the index vectors in this new Mv5.x model exceed the predetermined threshold value then that model may be deemed to have been accepted (194). Here again the system may loop through index vector in the index vector pool (182) until a model has been deemed accepted by exceeding the predetermined threshold value of the t-test. If a model has been accepted the model residuals may be calculated and the correlation between the model residuals and the index vectors remaining in the pool may be calculated (196). It is understood that index vector combinations from the previously selected and saved Mv5.1m model may be flagged so that redundancies, i.e., selecting the same combination of index vectors more than once, may be flagged and considered during this final removal and multiple modeling building stage of incremental feature selection. Here again the system may loop through the lowest t-test ranking index vector and re-building loop and sub-loop until the last index is reached (198). Once the last index vector is reached in this loop and sub-loop, this sub-process may stop (208) and exit with the understanding that multiple Mv5.1m models may have been created and been deemed acceptable and saved (204) by the system.

Once the Mv5.1m models have been created and stored, a list of the model objects may be created (220) as shown on FIG. 4. FIG. 4 demonstrates the model selection process of incremental feature selection wherein several evaluation calculations are conducted and a programmatic determination is reached as to the ‘best’ model. First, each model is scored by determining the root mean squared in-sample error (RMSE_{Sample}).

$$R M S {E}_{Sample} = \sqrt{\frac{{\sum }_{k = 1}^{n} {( y - \hat{y} )}^{2}}{n}}$$

The next evaluation factor calculates the out-of-sample error factor (224). For each vector set, here the five vectors in the set for each Mv5.1m model, one year of data is removed and a new Mv5.1m is created with the remaining years index vectors. The missing year is then applied to the model and an output of the model y(hat) can be determined. Y(hat) can then be differenced from the actual y or yield for that missing year (228). This may be repeated for each year of the index vector set, e.g., in the case of Weather Analytics at least 30 years of weather data and yield data (230). The out of sample root mean squared error can then be returned (232) by using the same RMSE formula as with the sample error above with the y(hat) difference from y (actual) for the depth of the index vectors, e.g., 30 years of data.

The next evaluation factor is called herein the forecast error (242). For each Mv5.1m model the vector index group may be grouped as an expanding window of data as it relates to subsequent years (244). For example, data for only the first twenty years may be used to create an Mv5.1m model for the index vector group. The next year's data, here, year 21, may be applied to that model and a y(hat) prediction may be determined. This y(hat) may be differenced from the y(actual) for that year. Next, a Mv5.1m model may be created using the first 21 years of data and the next year, here year 22, may be applied to the model and a y(hat).year.22 may be differenced from the y(actual) for year four. Next the window may be expanded for the first four years data and a Mv5.1m model may be created and the next year's data, here year 23, may be applied and a y(hat).year.23 may be differenced from the y(actual). This window of data may be expanded to the at least 30 years of index vector—yield one year at a time until the last year (246) is reached. The forecast error is then returned as root mean squared error of the differences between the y(hat)s and the y(actual)s.

Having now calculated the in-sample, out-of-sample, and so called forecast error, a predetermined, albeit heuristic, calculation may be applied to determine a model selection.

$$Model Score = \frac{R M S {E}_{Sample} + R M S {E}_{Out \text{-} of \text{-} Sample} + R M S {E}_{Forecast}}{3}$$

The best model is the one with the lowest model score, and the rest of the models are ranked in order from lowest score to highest.

The incremental feature selection model builder may be repeated for each of the geo-spatial entities for which index vector pairs may have been created. And therefore a plurality of models, one for each specific geo-spatial resolution unit, may be run and accumulated to provide crop yield estimates and predictions for larger geographical area or political units, such as predicted corn yield for the United States domestic production. It is understood, however, that even though hyper-local weather data (geo-spatial resolution greater than approximately 5 kilometers) may be available from sources such as Weather Analytics, and in some areas very small yield reports are available, such as, and individual domestic farm yield reports via the United States crop insurance program, and as such very small geo-spatial units and its associated index vector pool may be created, experience has shown that hyper-local modeling does not improve crop yield prediction. It is estimated that this may be due to anomalous behavior or extreme local conditions. Therefore, it is understood that the smallest geo-spatial resolution useful as the best mode herein is about the size of a mid-western United States county area. It is understood that geo-spatial resolution of about this size appears, based on experience, to self-normalize for these potential local anomalous yield reports.

### Component Analysis

Having now obtained a linear model for the prospective crop yield, the system now turns to its techniques for providing predictive analysis using the said models. FIG. 5 demonstrates a block diagram of the component analysis used in the system. Model objects (260) are input to FIG. 5. It is understood that the model object as defined herein may contain the name of the index vector and or the index vector object. The index vector object may contain the formula for creating index. Within the index formula are weather data variables. The index formulas may be extracted from the object slot (262). A time series for the variables contain the index formula objects may be created (264). For example, if the precipitation variable is used, the system extract 30 years of daily precipitation data. Daily precipitation data may be calculated by summing the 24-hour time. It is understood the weather data source, such as that provided by weather analytics, provides weather data variables on a predetermined geospatial resolution for each hour of the 24-hour day. Each time series may be considered one discrete time series, for example, January 1 to December 31, for a particular year for precipitation. The years corresponding to the time series may be placed in an index stack (266). A spectrum analysis may be performed on the index stack of time series to determine the number of primary spectral components of the time series. Once the number of primary spectral components has been calculated, this N value of spectral components may be used by the subsequent principal components analysis as a parameter for the components calculations. It is understood that, for the purpose of the present system, in no case is the N parameter of the principal components analysis set to less than 5 components. The principal components may now be calculated with the proper spectral setting (270). The principal components of the time series may be returned (272).

More specifically, for example, the index vector may contain the formula for July total precipitation. Here, that formula could be represented as:

July.total.precip=sum(july.daily.sum.1+july.daily.sum.2 . . . july.daily.sum.31)/31

Wherein for example july.daily.sum.n=GET https://api.weatheranalytics.com/v1/core/35/['40.742,−62.812]?startDate=07%2F01%2F2015&endDate=07%2F31%2F2015&interval=daily&units=metric&fields=precipitationPreviousHourCentimeters&time=1wt&format=csv&station=cfsr&userKey=userkey

Since, in this example, this formula used PRECIP as the weather data variable, it is recognized that an estimation model needs to be created for this underlying weather data variable and once obtained the index vector that uses this underlying variable can be constructed.

The system may proceed as follows:

N_day=365.

N_data=number of years X number of locations of data.

$$X = ( \begin{matrix}{X}_{11} & {X}_{12} & … & {X}_{INdata} \\ {X}_{21} & ⋱ & & ⋮ \\ ⋮ & & & \\ {X}_{{Nday}_{1}} & … & {X}_{Nday} & Ndata\end{matrix} )$$

Where Xij is the deviation (departure from typical) for one weather variable for day-of-year (i) and year/location (j), as in FIG. 7 (336). Once the data is collected into this matrix format, the Eigenvectors of the data may be calculated as follows:

X_{COV}=X·X^{T}

V=N_{day}×N_{day}

W=N_{day}×N_{day}

P=N_{day}×10

Thus providing the V matrix of eigenvectors of Xcov. The W diagonal matrix of eigenvalues of Xcov. And the P matrix of the 1^{st} 10 vectors in V(i) ordered by eigenvalues. This yields the principal components of the weather data time series as represented here:

$$= ( \begin{matrix}{V}_{11} & {V}_{12} & … & {V}_{10} \\ {V}_{21} & & & \\ ⋮ & ⋱ & & ⋮ \\ {V}_{Nday 1} & … & & {V}_{Nday 10}\end{matrix} )$$

### Principal Components

Next the covariance matrix of the principal components, Pcov, may be specified as a 10×10 diagonal matrix of the first 10 eigenvalues in W as follows:

$$= ( \begin{matrix}{W}_{11} & o & o & … & O \\ o & {W}_{22} & & & \\ o & & & & \\ ⋮ & & ⋱ & & ⋮ \\ O & & … & & {W}_{1010}\end{matrix} )$$

Having now obtained the principal components and the covariance matrix of the principal components, as shown in FIG. 6 (304) and FIG. 7 (346), the system may now proceed to an optimal interpolation of the weather data variable time series, shown in FIG. 6 (292) and FIG. 7 (338). Here, the number of days in the current year remaining is less than 365 days and one location is analyzed at a time. And N(data) is the number of locations of the weather variable data.

$$X = ( \begin{matrix}{X}_{11} & {X}_{12} & … & {X}_{INdata} \\ {X}_{21} & & & \\ ⋮ & ⋱ & & \\ {X}_{{day}_{1}} & … & {X}_{Nday} & Ndata\end{matrix} )$$

Where X(i)(j) is the deviation (departure from typical) for one weather data variable for the day-of-year (i) and the location (j). From this a subset of the deviations for the location (j) may be determined:

$${X}_{j} = ( \begin{matrix}{X}_{1 j} \\ {X}_{2 j} \\ ⋮ \\ {X}_{Nday j}\end{matrix} )$$

And the error variance for the weather data variable may formatted as matrix:

$${R}_{j} = ( \begin{matrix}{r}_{11} & o & … & O & \\ o & {r}_{22} & & ⋮ & \\ ⋮ & & ⋱ & & \\ o & & & {r}_{Nday} & {N}_{day}\end{matrix} )$$

Now the principal component matrix, as provided above, may be formatted in this matrix:

$$H = ( \begin{matrix}{P}_{11} & {P}_{12} & … & {P}_{110} \\ {P}_{21} & & & \\ ⋮ & & & \\ {P}_{{Nday}_{1}} & & … & {P}_{{Nday}_{10}}\end{matrix} )$$

Where P(i)(j) are elements of the principal components matrix P from above. Now best-fit principal component coefficients for the current year may be calculated:

Kj=P_{KW}·H^{T}·((H·P_{COV}·H^{T})−Rⱼ)⁻¹

Fj=Kj−Xj

And the error covariance matrix for such principal component coefficients may be derived:

Aj=(I−Kj·H)·P_{cov}

These are shown in FIG. 7 (330).

Now randomized possible future weather deviations for the remainder of the year may be calculated FIG. 7 (332),(340), (348), (342):

Fⱼₖ=N(Fⱼ, Aj)

X_{fitjk}=P·Fⱼₖ

where N(Fj, Aj) represents taking a random sample, k, of the multivariate normal distribution with mean Fj and covariance Aj.

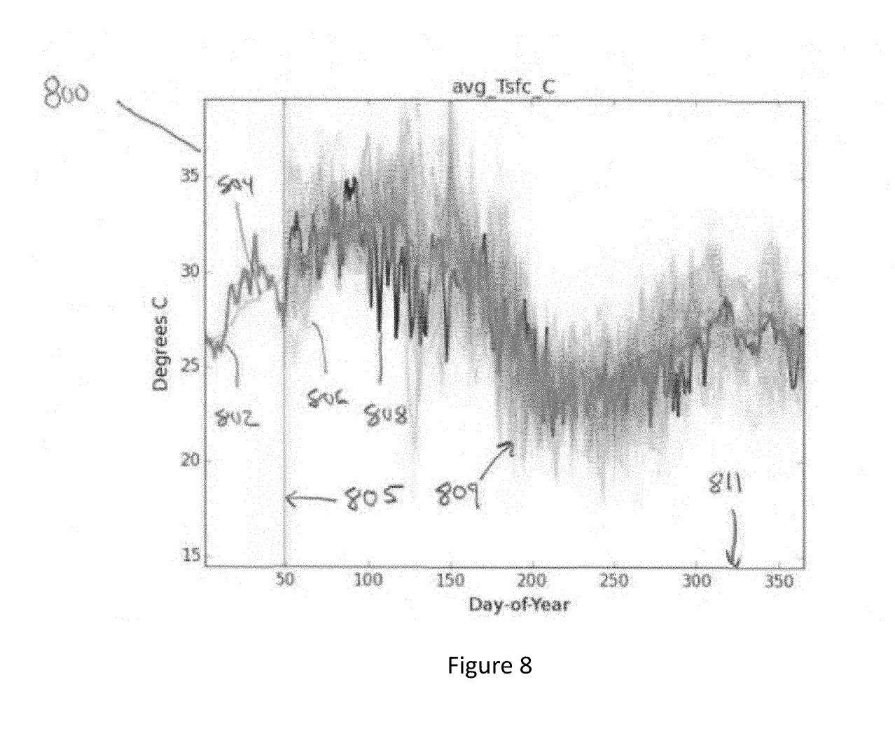

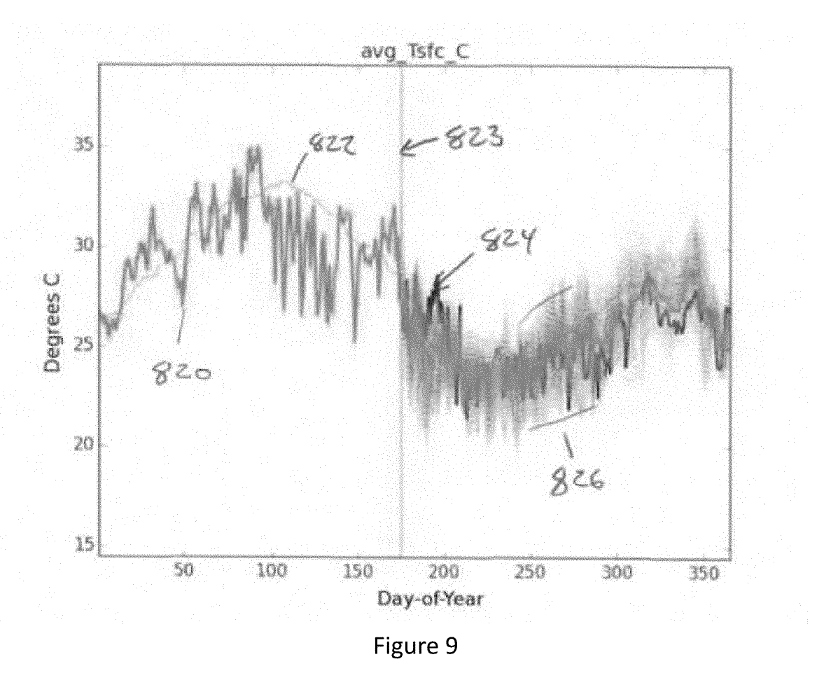

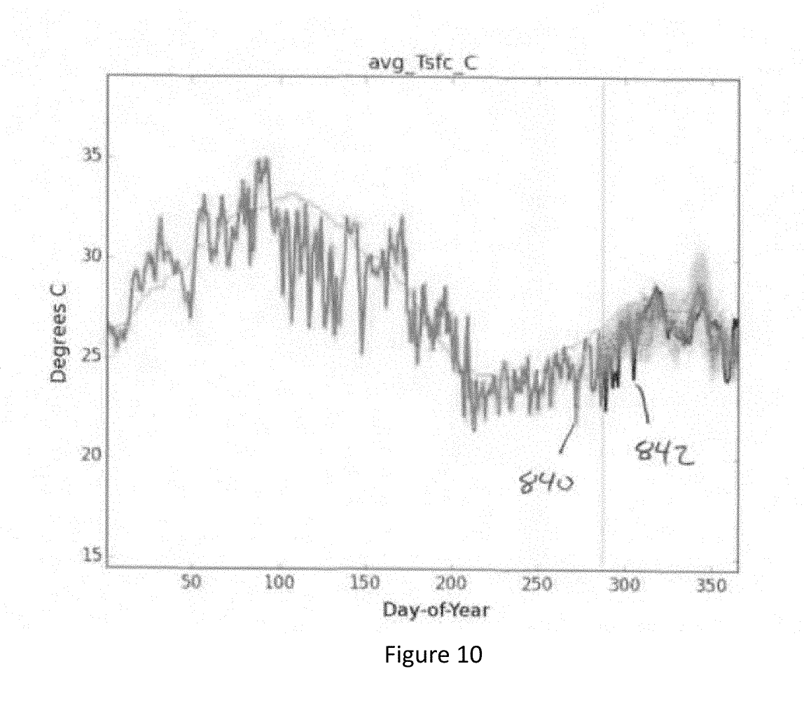

The predetermined weather climatology model for the specific location and weather variable being analyzed can be added to such deviations FIG. 7 (334) to obtain possible future weather scenarios for the current year FIG. 7 (324) and FIG. 6 (306). Such scenarios may be applied to the index formula (286) to create an index vector. FIG. 8 demonstrates the results of said spectrum constrained processing. For example, a weather data variable such as temperature (800) may be plotted. The actual observations for the weather data variable for that year may be graphed (802) and (808). The climatology model may also be graphed (804). At day 50, for example, (805) the system may generate the multiple scenarios for that weather data variable for the remainder of the year. This is shown by the multiple line plots (809) extending from the right of the current day (805) as delineated by the day index (811). FIG. 9 demonstrates the output generated at day (823) 175 wherein actual observations are plotted (820) and the climatology model is displayed (822) and the multiple weather data scenarios for the remainder of the year are plotted (826). FIG. 10 demonstrates the output at an even later date than FIG. 9, wherein the black line (842) shows the actual weather data and the gray line (84) shows the simulated scenarios. Hence the contrast between FIGS. 8, 9 and 10 demonstrate how the spectral techniques described herein narrow the possible outcomes for the remainder of the calendar year as the actual observed variable (820) is input as the initial conditions for the principal component model.

The entire system of principal component analysis and optimal interpolation may be applied for all weather variables and locations used in the predetermined Mv5 model (294), so that such model may be run to calculate crop yield predictions for the current year (308), (310).

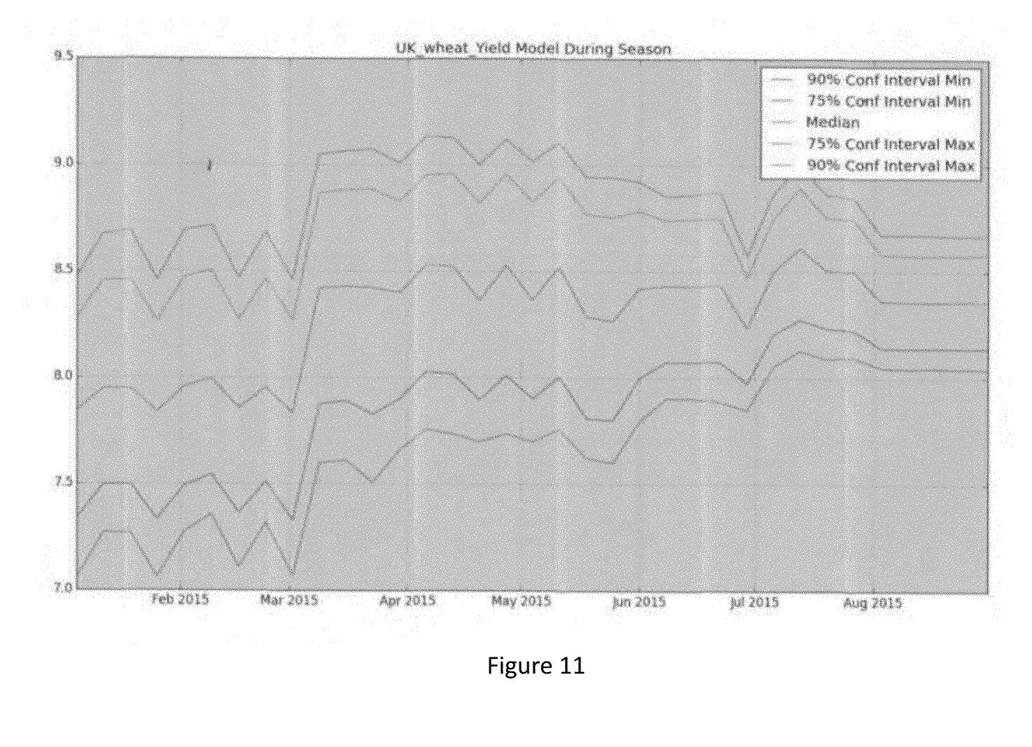

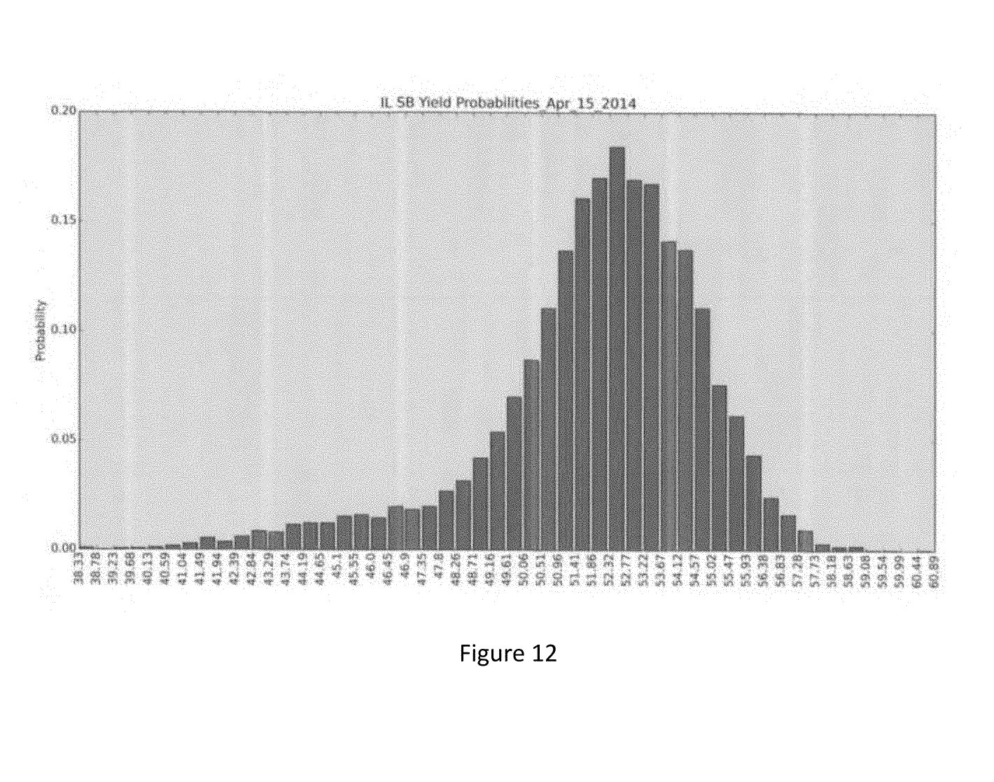

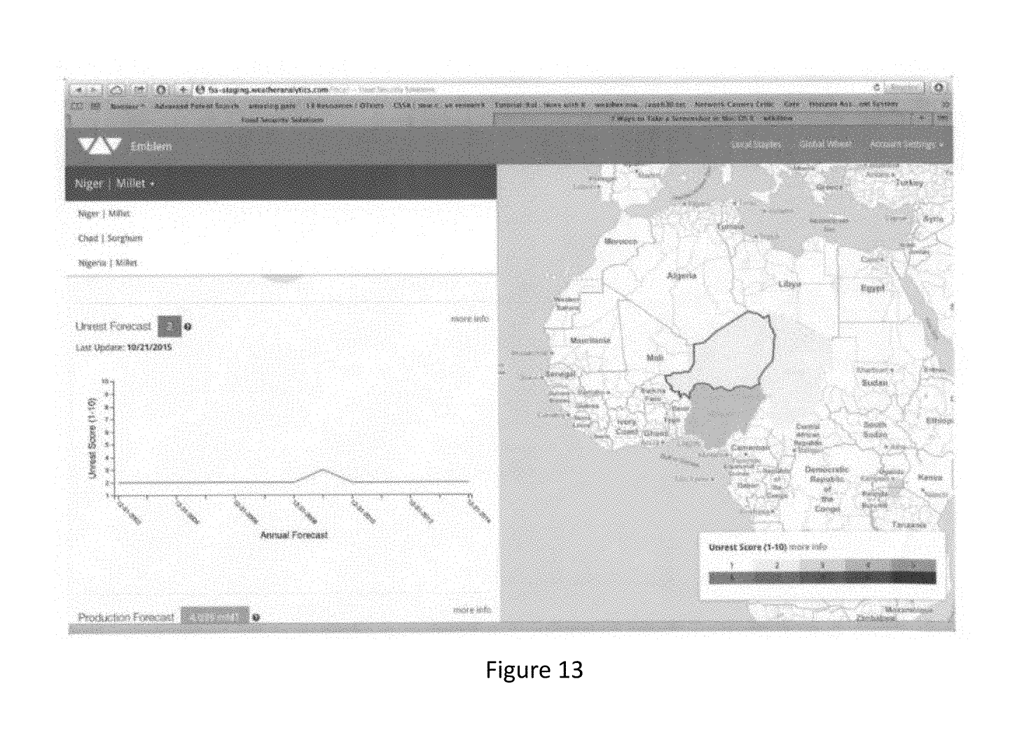

The results of said incremental feature selection modeling and said spectrum constrained components analysis may then be used to create data for display at the graphical user interface. FIG. 10 demonstrates the output of the Mv5 linear model with the index vectors generated by the spectrum constrained principal component system herein. It demonstrates the median and 75% and 95% confidence intervals from the multiple outputs of the model, e.g., one output for each of the generated potential weather data variable scenarios as applied to the index vector formula and then to the Mv5 linear model. FIG. 11 shows a histogram output of the Mv5 linear model as powered by the weather data scenario generator. FIG. 12 shows that the crop yield predictions of the present invention can be used to power ancillary predictive measures such as social unrest.

What is claimed is:

1. A system for determining crop yields using incremental feature selection and spectrum constrained scenario generation comprising:
a data structure that stores historical observed weather data variables, said weather data variables having geospatial encoding, temporal encoding and a variable name;
an index generator operationally connected to said data structure storing said geospatially and temporally encoded weather data variables, said index generator calculating a plurality of index values; said index values being geospatially and temporally calculated to correspond to an adjusted crop yield observational value; said index generator creating a plurality of index vectors for each geospatially adjusted crop yield value, said index generator creating an in-sample matrix comprising a stack of said crop yield vector pairs;
a crop yield predictor model generator that calculates a model with said in-sample vector matrix;
an incremental feature selection model builder, said incremental feature selection model builder determining from 4 to 6 index features having the greatest statistical relation to a model generated by said crop yield model generator;
a principal component generator, said principal component generator connected to said data structure containing said historical geospatially and temporally encoded weather data variables, said principal component generator determining the coefficients of the principal component of each of said index vectors selected by said incremental feature selection model builder, said crop yield predictor giving a model fit from said between 4 to 6 index predictors selected via said incremental feature selection model builder and said predetermined crop yield;
an assimilation fit generator, said assimilation fit generator operationally connected to said data structure containing said geospatially and temporally encoded weather data variables, said fit generator create a plurality of time series for each of said weather data variable used in said index vector, each of said time series generated being constrained to the spectrum determined from said weather data variable time series; and
a graphical display of said predicted crop yield.

2. A system for the creation of an at least a five index vector linear model, said linear model having a fit with a predetermined measurement and a plurality of potential index vectors (an index vector pool), each index vector having an index formula and the predetermined measurement, said system performing the steps of:
determining the correlation between the plurality of index vectors with the predetermined measurement, ranking and selecting the index vector with the highest correlation value from the index vector pool;
creating a one variable linear model between said selected first index vector and said predetermined measurement and then calculating the residuals of the linear model with said first selected index vector;
determining the correlation between the said residuals and said plurality of index vectors remaining in said index vector pool, ranking and selecting a second index vector, said second index vector having the highest correlating value from the plurality of index vectors remaining in said index vector pool;
creating a two variable linear model with said first selected index vector and said second selected index vector and said predetermined measurement;
determining the t-test value of said two variable linear model with said first and said second selected index vectors and rejecting said two variable linear model if said t-test does not exceed a predetermined threshold value and creating a new two index vector linear model using the next highest correlated index vector from said index vector pool as the second index vector until a two index vector linear model provides a calculated t-test value greater than the predetermined threshold value;
determining the second residuals of said two index vector linear model and calculating the correlation between said second residuals and the index vectors remaining from said plurality of index vectors in said index vector pool, ranking and selecting the highest correlated index vector from said ranked index vectors as the third index vector;
creating a three variable linear model with said first selected index vector, said second selected index vector and said third selected index vector and said predetermined measurement;
determining a t-test value of said three variable linear model with said first, second and third selected index vectors and rejecting said three variable linear model if said t-test for any of said first, second or third index vectors does not exceed a predetermined threshold value and selecting the next highest ranking index vector from the correlation with said second residuals and using said next selected vector as the third vector for creating a three variable linear model and repeating said t-test rejection until a three variable linear model exceeds said predetermined t-test threshold value;
determining third residuals of said three vector linear model and calculating the correlation between said third residuals and the index vectors remaining from said plurality of index vectors in said index vector pool, ranking and selecting the highest correlated index vector from said ranked index vectors as the fourth index vector;
creating a four variable linear model with said first selected index vector, said second selected index vector, said third selected index vector and said fourth selected index vector and said predetermined measurement;
determining a t-test value of said four variable linear model with said first, second, third and fourth selected index vectors and rejecting said four variable linear model if said t-test for any of said first, second, third or fourth index vectors does not exceed a predetermined threshold value and selecting the next highest ranking index vector from the correlation with said third residuals and using said next selected vector as the fourth vector for creating a four variable linear model and repeating said t-test rejection until a four variable linear model exceeds said predetermined t-test threshold value;
determining a fourth residual of said four vector linear model and calculating the correlation between said fourth residuals and the index vectors remaining from said plurality of index vectors in said index vector pool, ranking and selecting the highest correlated index vector from said ranked index vectors as the fifth index vector;
creating a five variable linear model with said first selected index vector, said second selected index vector, said third selected index vector, said fourth selected index vector and said fifth index vector and said predetermined measurement;
determining a t-test value of said five variable linear model with said first, second, third, fourth and fifth selected index vectors and rejecting said fifth variable linear model if said t-test for any of said first, second, third, fourth or fifth index vectors does not exceed a predetermined threshold value and selecting the next highest ranking index vector from the correlation with said fourth residuals and using said next selected vector as the fifth vector for creating a five variable linear model and repeating said t-test rejection until a five variable linear model exceeds said predetermined t-test threshold value; and
saving said five vector linear model that exceeded said predetermined t-test threshold value.

3. The system of claim 2 further performing the steps of:
determining an in-sample, out-of-sample and forecast error score for said saved five vector linear model and determining an in-sample, out-of-sample and forecast error score for a second saved five vector index model; and
selecting the lowest scoring and highest ranking five vector index linear model between said first and said second five vector linear index model.

4. The system of claim 3 further performing the steps of:
determining a weather data variable name from at least one index vector that was used for said selected five index vector linear model;
retrieving a time series for said weather data variable from a weather data variable storage repository, said time series having at least three calendar years of weather data variables;
determining the principal components of said weather data variable time series;
generating a plurality of weather data variable scenarios from said principal components of said weather data variable time series; and
applying said plurality of weather data variable time series to said selected five index vector linear model and displaying the crop yield prediction of said five index vector linear model on a graphical user interface.

5. A system for generating a plurality of weather data variable time series, wherein said time series is spectrally constrained by the components and optimal interpolation of a plurality of historical weather data variable timer series, the system performing the steps of:
retrieving a plurality of historical weather data variable time series for a predetermined geo-location from a weather data variable storage repository;
determining the principal components of said plurality of historical weather data variable time series, wherein at least five components of said weather data variable time series are determined; and
for said geo-location, applying a climatology model, said at least five determined principal components and year-to-date weather data variable time series for said geo-location of optimal interpolation assimilation to generate a plurality of projected weather data variable timer series scenarios for the remainder of said annual time series for said predetermined geo-location.

6. The system of claim 1, wherein said index generator creates index vector objects that include non-weather data variables.

7. The system of claim 6, wherein said non-weather data variables includes data specific to a particular crop.

8. The system of claim 1, wherein said incremental feature selection model builder uses five index features having the greatest statistical relation to said model generated by said crop yield model generator.

9. The system of claim 2, wherein said predetermined threshold value for said t-tests is incrementally reduced if all of said index vectors fail to produce an accepted linear model.

10. A computer-implemented method for building a crop yield prediction model, comprising executing on a processor the steps of:
creating index vectors that each include an index formula, names of baseline weather data variables, yield variables, yield values and an associated polygon;
determining a correlation between the index vectors and a yield measurement, then ranking and selecting a first index vector with a highest correlation value;
creating a one variable linear model between the first index vector and the yield measurement;
determining a second index vector of the remaining index vectors that has the highest correlation to the yield measurement;
creating a two variable linear model with the first index vector, the second index vector and the yield measurement;
determining a t-test value of the two variable linear model with the first and second index vectors and rejecting the two variable linear model if the t-test for any of said first or second index vectors does not exceed a predetermined threshold value and creating a new two variable linear model using a next highest correlated index vector as the second index vector until a two variable linear model provides a calculated t-test value greater than the predetermined threshold value;
determining a third index vector of the remaining index vectors that has the highest correlation to the yield measurement;
creating a three variable linear model with the first index vector, the second index vector and the third index vector and the yield measurement;
determining a t-test value of the three variable linear model with the first, second and third index vectors and rejecting the three variable linear model if the t-test for any of said first, second or third index vectors does not exceed a predetermined threshold value and creating a new three variable linear model using a next highest correlated index vector as the third index vector until a three variable linear model provides a calculated t-test value greater than the predetermined threshold value;
determining a fourth index vector of the remaining index vectors that has the highest correlation to the yield measurement;
creating a four variable linear model with the first index vector, the second index vector, the third index vector, the fourth index vector and the yield measurement;
determining a t-test value of the four variable linear model with the first, second, third, and fourth index vectors and rejecting the four variable linear model if the t-test for any of said first, second, third or fourth index vectors do not exceed a predetermined threshold value and creating a new four variable linear model using a next highest correlated index vector as the fourth index vector until a four variable model provides a calculated t-test value greater than the predetermined threshold value;
determining a fifth index vector of the remaining index vectors that has the highest correlation to the yield measurement;
creating a five variable linear model with the first index vector, the second index vector, the third index vector, the fourth index vector, the fifth index vector and the yield measurement; and
determining a t-test value of the five variable linear model with the first, second, third, fourth, and fifth index vectors and rejecting the five variable linear model if the t-test for any of said first, second, third, fourth, or fifth index vectors do not exceed a predetermined threshold value and creating a new five variable linear model using a next highest correlated index vector as the fifth index vector until a five variable linear model provides a calculated t-test value greater than the predetermined threshold value;
storing the five variable linear model in a memory.

11. The computer-implemented method for building a crop yield prediction model of claim 10, further comprising calculating residuals for one or more of the models.
